(19) United States
(12) Patent Application Publication
(10) Pub. No.: US 2025/0167968 A1
(43) Pub. Date: May 22, 2025

(54) Unified Transmission Configuration Indication (TCI) States

(71) Applicant: Telefonaktiebolaget LM Ericsson (publ), Stockholm (SE)

(72) Inventors: Andreas Nilsson, Göteborg (SE); Siva Muruganathan, Stittsville (CA)

(21) Appl. No.: 18/842,166

(22) PCT Filed: Mar. 2, 2023
(86) PCT No.: PCT/EP2023/055280

§ 371 Date: Aug. 28, 2024

Related U.S. Application Data
(60) Provisional application No. 63/316,962, filed on Mar. 4, 2022.

(51) Int. Cl. H04L 5/00; H04W 72/23

(52) U.S. Cl. CPC H04L 5/0091; H04L 5/0035; H04W 72/23

(57) ABSTRACT

A method is performed by a communication device (12) configured for use in a communication network (10) is disclosed. The communication device (12) receives, for each of one or more uplink channels or signals (20), a configuration (24) that indicates with which of multiple activated unified transmission configuration indication, TCI, states (16) the uplink channel or signal (20) is associated. In some embodiments, the communication device (12) determines, for each of the one or more uplink channels or signals (20), a spatial filter for the uplink channel or signal (20) based on one or more activated unified TCI states (16) that are associated with the uplink channel or signal (20) according to the configuration (24) received for that uplink channel or signal (20). The communication device (12) may then transmit the one or more uplink channels or signals (20) using the one or more spatial filters determined for the one or more uplink channels or signals (20).

### TECHNICAL FIELD

The present application relates generally to a communication network, and relates more particularly to configuration of an uplink channel or signal in such a communication network.

### BACKGROUND

A transmission configuration indication (TCI) state contains quasi co-location (QCL) information between antenna ports of a communication device. In a spatial relation TCI state framework, a TCI state applies to an individual channel or signal. In a unified TCI state framework, by contrast, a TCI state applies to multiple channels or signals.

Challenges exist, however, in implementing the unified TCI state framework in a scheme where a communication device performs uplink transmissions towards multiple transmission reception points (TRPs). To support such a scheme, multiple unified TCI states would need to be activated for use by the communication device. Challenges in this case include how to associate the multi-TRP uplink transmissions with one or more of the unified TCI states that are activated, especially in a way that minimizes signaling overhead.

### SUMMARY

It may be an object of the present disclosure to provide methods and devices which may enable an association between multi-TRP uplink transmissions with one or more of unified TCI states that are activated in a way that may minimize signaling overhead.

According to some embodiments herein, a communication network configures with which of multiple activated unified TCI states each of one or more uplink channels or signals is associated. Some embodiments may thereby configure activated unified TCI state association per uplink channel or signal. In some embodiments, for example, the configuration for each uplink channel or signal exploits a TCI state pointer (e.g., a common beam index) that points to one or more of the activated unified TCI states with which the uplink channel or signal is associated. The TCI pointer may for instance point to one or more activated unified TCI states by pointing to one or more indices or identifiers that TCI state activation signaling associates with those one or more activated unified TCI states. These and other embodiments may advantageously configure activated unified TCI state association as needed for multi-TRP uplink transmission, while minimizing signaling overhead.

More particularly, embodiments herein include a method performed by a communication device configured for use in a communication network. The method comprises receiving, for each of one or more uplink channels or signals, a configuration that indicates with which of multiple activated unified transmission configuration indication, TCI, states the uplink channel or signal is associated.

In some embodiments, the configuration for each uplink channel or signal includes a TCI state pointer that points to one or more of the multiple activated unified TCI states with which the uplink channel or signal is associated. In one or more of these embodiments, the TCI state pointer is a common beam index. In one or more of these embodiments, activation signaling that activates the multiple unified TCI states associates the multiple unified TCI states with respective indices or identifiers. In some embodiments, the TCI state pointer included in the configuration for each uplink channel or signal points to one or more activated unified TCI states by pointing to the one or more indices or identifiers associated with the one or more activated unified TCI states. In one or more of these embodiments, the multiple activated unified TCI states includes first and second activated unified TCI states. In some embodiments, the activation signaling associates the first and second activated unified TCI states with first and second identifiers, respectively. In some embodiments, the TCI state pointer included in the configuration for at least one uplink channel or signal points to the first activated unified TCI state and/or the second activated unified TCI state by pointing to the first identifier, the second identifier, or both the first identifier and the second identifier. In one or more of these embodiments, the multiple activated unified TCI states includes first and second activated unified TCI states. In some embodiments, the activation signaling associates the first and second activated unified TCI states with first and second identifiers, respectively. In some embodiments, a field in downlink control signaling indicates whether the TCI state pointer included in the configuration for at least one uplink channel or signal points to the first activated unified TCI state and/or the second activated unified TCI state by pointing to the first identifier, the second identifier, or both the first identifier and the second identifier. Alternatively, a field in downlink control signaling indicates whether the TCI state pointer included in the configuration for at least one uplink channel or signal points to the first activated unified TCI state and/or the second activated unified TCI state by pointing to the second identifier, the first identifier, or both the second identifier and the first identifier. In one or more of these embodiments, the activation signaling includes a first field that activates the first activated unified TCI state and a second field that activates the second activated unified TCI state. In some embodiments, the first field occurs before the second field in the activation signaling. In one or more of these embodiments, the method further comprises receiving the activation signaling. In one or more of these embodiments, the activation signaling is received after receipt of the configuration for at least one of the one or more uplink channels or signals.

In some embodiments, the configuration for each uplink channel or signal explicitly indicates with which of the multiple activated unified TCI states the uplink channel or signal is associated.

In some embodiments, the multiple activated unified TCI states are associated with multiple respective transmission reception points, TRPs.

In some embodiments, said receiving comprises receiving, for each of one or more uplink channels, a configuration that indicates with which of multiple activated unified TCI states the uplink channel is associated. In one or more of these embodiments, the one or more uplink channels include an uplink data channel. In one or more of these embodiments, the uplink data channel is a Physical Uplink Shared Channel, PUSCH. In one or more of these embodiments, the configuration received for the PUSCH is a PUSCH configuration or a PUSCH serving cell configuration.

In some embodiments, the configuration for at least one uplink channel or signal includes a field that indicates whether a unified TCI framework or a spatial relation framework applies.

In some embodiments, said receiving comprises receiving, for each of one or more uplink signals, a configuration that indicates with which of multiple activated unified TCI states the uplink signal is associated. In one or more of these embodiments, the one or more uplink signals are one or more sounding reference signal, SRS, signals. In one or more of these embodiments, the one or more SRS signals are one or more SRS signals in one or more SRS resource sets. In one or more of these embodiments, the configuration for an SRS signal in an SRS resource set indicates with which of the multiple activated unified TCI states the SRS signal in that SRS resource set is associated by indicating with which of the multiple activated unified TCI states the SRS resource set is associated. In one or more of these embodiments, the configuration received for each of the one or more SRS signals in the one or more SRS resource sets is an SRS resource set configuration. In one or more of these embodiments, the one or more SRS signals are one or more SRS signals in one or more SRS resources of the same SRS resource set. In one or more of these embodiments, the configuration for an SRS signal in an SRS resource of the SRS resource set indicates with which of the multiple activated unified TCI states the SRS signal in that SRS resource is associated by indicating with which of the multiple activated unified TCI states the SRS resource is associated. In one or more of these embodiments, the configuration received for each of the one or more SRS signals in the one or more SRS resources of the SRS resource set is an SRS resource configuration.

In some embodiments, each activated unified TCI state contains quasi co-location, QCL, information between antenna ports of the communication device.

In some embodiments, each activated unified TCI state is applicable for multiple channels or signals.

In some embodiments, the multiple activated unified TCI states are joint uplink/downlink TCI states. In some embodiments, each joint TCI state is applicable for both downlink transmissions and uplink transmissions.

In some embodiments, the multiple activated unified TCI states are uplink TCI states. In some embodiments, each uplink TCI state is applicable only for uplink transmissions.

In some embodiments, the method further comprises determining, for each of the one or more uplink channels or signals, a spatial filter for the uplink channel or signal based on one or more activated unified TCI states that are associated with the uplink channel or signal according to the configuration received for that uplink channel or signal. In one or more of these embodiments, the method further comprises transmitting the one or more uplink channels or signals using the one or more spatial filters determined for the one or more uplink channels or signals.

In some embodiments, the multiple activated unified TCI states (16) are multiple unified TCI states that physical layer signaling indicates are to be used by the communication device (12) for determining one or more spatial filters for one or more uplink transmissions.

Other embodiments herein include a method performed by a network node configured for use in a communication network. The method comprises transmitting, to a communication device, for each of one or more uplink channels or signals, a configuration that indicates with which of multiple activated unified transmission configuration indication, TCI, states the uplink channel or signal is associated.

In some embodiments, the configuration for each uplink channel or signal includes a TCI state pointer that points to one or more of the multiple activated unified TCI states with which the uplink channel or signal is associated. In one or more of these embodiments, the TCI state pointer is a common beam index. In one or more of these embodiments, activation signaling that activates the multiple unified TCI states associates the multiple unified TCI states with respective indices or identifiers. In some embodiments, the TCI state pointer included in the configuration for each uplink channel or signal points to one or more activated unified TCI states by pointing to the one or more indices or identifiers associated with the one or more activated unified TCI states. In one or more of these embodiments, the multiple activated unified TCI states includes first and second activated unified TCI states. In some embodiments, the activation signaling associates the first and second activated unified TCI states with first and second identifiers, respectively. In some embodiments, the TCI state pointer included in the configuration for at least one uplink channel or signal points to the first activated unified TCI state and/or the second activated unified TCI state by pointing to the first identifier, the second identifier, or both the first identifier and the second identifier. In one or more of these embodiments, the multiple activated unified TCI states includes first and second activated unified TCI states. In some embodiments, the activation signaling associates the first and second activated unified TCI states with first and second identifiers, respectively. In some embodiments, a field in downlink control signaling indicates whether the TCI state pointer included in the configuration for at least one uplink channel or signal points to the first activated unified TCI state and/or the second activated unified TCI state by pointing to the first identifier, the second identifier, or both the first identifier and the second identifier. Alternatively, a field in downlink control signaling indicates whether the TCI state pointer included in the configuration for at least one uplink channel or signal points to the first activated unified TCI state and/or the second activated unified TCI state by pointing to the second identifier, the first identifier, or both the second identifier and the first identifier. In one or more of these embodiments, the activation signaling includes a first field that activates the first activated unified TCI state and a second field that activates the second activated unified TCI state. In some embodiments, the first field occurs before the second field in the activation signaling. In one or more of these embodiments, the method further comprises transmitting the activation signaling. In one or more of these embodiments, the activation signaling is transmitted after transmission of the configuration for at least one of the one or more uplink channels or signals.

In some embodiments, the configuration for each uplink channel or signal explicitly indicates with which of the multiple activated unified TCI states the uplink channel or signal is associated.

In some embodiments, the multiple activated unified TCI states are associated with multiple respective transmission reception points, TRPs.

In some embodiments, said transmitting comprises transmitting, for each of one or more uplink channels, a configuration that indicates with which of multiple activated unified TCI states the uplink channel is associated. In one or more of these embodiments, the one or more uplink channels include an uplink data channel. In one or more of these embodiments, the uplink data channel is a Physical Uplink Shared Channel, PUSCH. In one or more of these embodiments, the configuration transmitted for the PUSCH is a PUSCH configuration or a PUSCH serving cell configuration.

In some embodiments, the configuration for at least one uplink channel or signal includes a field that indicates whether a unified TCI framework or a spatial relation framework applies.

In some embodiments, said transmitting comprises transmitting, for each of one or more uplink signals, a configuration that indicates with which of multiple activated unified TCI states the uplink signal is associated. In one or more of these embodiments, the one or more uplink signals are one or more sounding reference signal, SRS, signals. In one or more of these embodiments, the one or more SRS signals are one or more SRS signals in one or more SRS resource sets. In one or more of these embodiments, the configuration for an SRS signal in an SRS resource set indicates with which of the multiple activated unified TCI states the SRS signal in that SRS resource set is associated by indicating with which of the multiple activated unified TCI states the SRS resource set is associated. In one or more of these embodiments, the configuration transmitted for each of the one or more SRS signals in the one or more SRS resource sets is an SRS resource set configuration. In one or more of these embodiments, the one or more SRS signals are one or more SRS signals in one or more SRS resources of the same SRS resource set. In one or more of these embodiments, the configuration for an SRS signal in an SRS resource of the SRS resource set indicates with which of the multiple activated unified TCI states the SRS signal in that SRS resource is associated by indicating with which of the multiple activated unified TCI states the SRS resource is associated. In one or more of these embodiments, the configuration transmitted for each of the one or more SRS signals in the one or more SRS resources of the SRS resource set is an SRS resource configuration.

In some embodiments, each activated unified TCI state contains quasi co-location, QCL, information between antenna ports of the communication device.

In some embodiments, each activated unified TCI state is applicable for multiple channels or signals.

In some embodiments, the multiple activated unified TCI states are joint uplink/downlink TCI states. In some embodiments, each joint TCI state is applicable for both downlink transmissions and uplink transmissions.

In some embodiments, the multiple activated unified TCI states are uplink TCI states. In some embodiments, each uplink TCI state is applicable only for uplink transmissions.

In some embodiments, the multiple activated unified TCI states (16) are multiple unified TCI states that physical layer signaling indicates are to be used by the communication device (12) for determining one or more spatial filters for one or more uplink transmissions.

Embodiments herein also include corresponding apparatus, computer programs, and carriers of those computer programs. For example, embodiments herein include a communication device configured for use in a communication network. The communication device is configured to receive, for each of one or more uplink channels or signals, a configuration that indicates with which of multiple activated unified transmission configuration indication, TCI, states the uplink channel or signal is associated. In some embodiments, the communication device is configured to determine, for each of the one or more uplink channels or signals, a spatial filter for the uplink channel or signal based on one or more activated unified TCI states that are associated with the uplink channel or signal according to the configuration received for that uplink channel or signal. In one or more of these embodiments, the communication device is further configured to transmit the one or more uplink channels or signals using the one or more spatial filters determined for the one or more uplink channels or signals.

Embodiments herein also include a network node configured for use in a communication network. The network node is configured to transmit, to a communication device, for each of one or more uplink channels or signals, a configuration that indicates with which of multiple activated unified transmission configuration indication, TCI, states the uplink channel or signal is associated.

### BRIEF DESCRIPTION OF THE DRAWINGS

FIG. 1 is a block diagram of a communication network in accordance with some embodiments.

FIG. 2 is a block diagram of a unified TCI state in accordance with some embodiments.

FIG. 3 is a block diagram of configuration(s) in accordance with some embodiments.

FIG. 4A is a block diagram of a configuration in an example where a communication device transmits PUCCH towards multiple TRPs in accordance with some embodiments.

FIG. 4B is a block diagram of a configuration in another example where a communication device transmits PUCCH towards multiple TRPs in accordance with some embodiments.

FIG. 4C is a block diagram of a configuration in yet another example where a communication device transmits PUCCH towards multiple TRPs in accordance with some embodiments.

FIG. 5 is a block diagram of a data scheduling in accordance with some embodiments.

FIG. 6 is a block diagram of an NR physical time-frequency resource grid in accordance with some embodiments.

FIG. 7 is a block diagram of an example where a PDCCH is repeated over two TRPs at different times in accordance with some embodiments.

FIG. 8 is a block diagram of an example where a PDCCH is transmitted simultaneously from two TRPs in the same time and frequency resource in accordance with some embodiments.

FIG. 9 is a block diagram of an example of a TDM Scheme B in accordance with some embodiments.

FIG. 10 is a block diagram of UL enhancement with multiple TRPs being performed by transmitting a PUCCH or PUSCH towards to different TRPs in accordance with some embodiments.

FIG. 11 is a block diagram of an example where PUCCH is repeated multiple times over multiple slots, with each repetition being towards a different TRP, in accordance with some embodiments.

FIG. 12 is a block diagram of PUSCH repetitions being transmitted towards different TRPs, in accordance with some embodiments.

FIG. 13 is a block diagram of a MAC CE activating a CSI-RS resource set in accordance with some embodiments.

FIG. 14 is a logic flow diagram of a method performed by a communication device in accordance with some embodiments.

FIG. 15 is a logic flow diagram of a method performed by a network node in accordance with some embodiments.

FIG. 16 is a block diagram of a communication device in accordance with some embodiments.

FIG. 17 is a block diagram of a network node in accordance with some embodiments.

FIG. 18 is a block diagram of a communication system in accordance with some embodiments

FIG. 19 is a block diagram of a user equipment according to some embodiments.

FIG. 20 is a block diagram of a network node according to some embodiments.

FIG. 21 is a block diagram of a host according to some embodiments.

FIG. 22 is a block diagram of a virtualization environment according to some embodiments.

FIG. 23 is a block diagram of a host communicating via a network node with a UE over a partially wireless connection in accordance with some embodiments.

### DETAILED DESCRIPTION

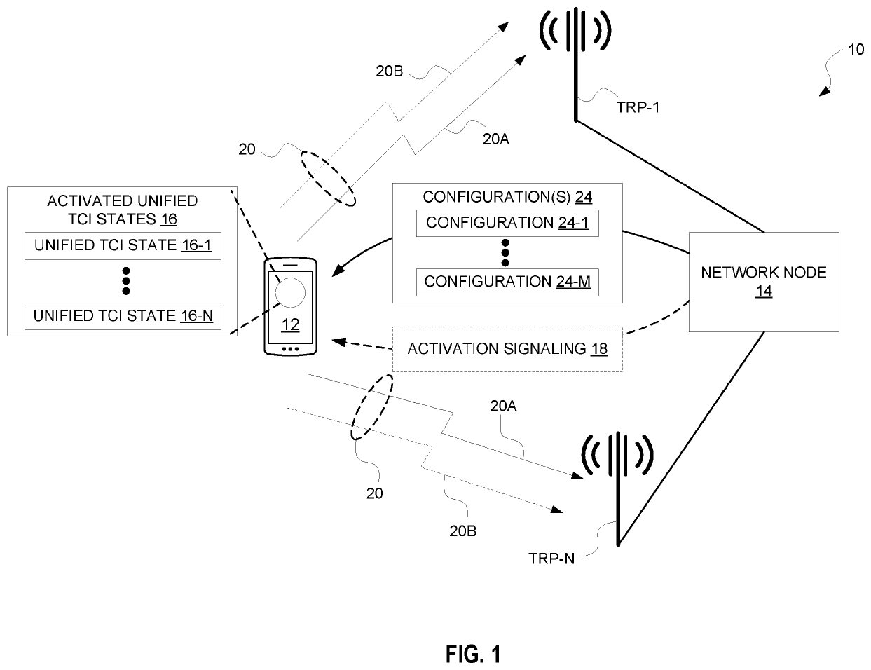

FIG. 1 shows a communication network 10 configured to provide communication service to a communication device 12 according to some embodiments. The communication network 10 in this regard may include a network node 14 configured to serve the communication device 12. In embodiments where the communication network 10 is a wireless communication network, such as a 5G wireless communication network, the network node 14 may be a radio network node (e.g., a base station) that serves the communication device 12 over a wireless interface.

As shown, the communication device 12 is configured to perform uplink transmission towards multiple transmission reception points (TRPs), shown as TRP-1 through TRP-N. These multiple TRPs may be distributed at different locations to cover different serving areas. Each TRP may include a set of antenna arrays and be under the control of the network node 14. In these and other embodiments, the communication device 12 may have multiple antenna panels (not shown), e.g., so that multiple uplinks can be established between the multi-TRPs of the network node 14 and the multi-panels of the communication device 12.

The communication device 12 in this regard may transmit one or more uplink channels or signals 20. As shown, for instance, the communication device 12 may transmit a first uplink channel or signal 20A, e.g., an uplink control channel such as a Physical Uplink Control Channel (PUCCH). In the example of FIG. 1, the communication device 12 may transmit this first uplink channel or signal 20A towards multiple TRPs TRP-1 . . . TRP-N. Alternatively or additionally, the communication device 12 may transmit a second uplink channel or signal 20B, e.g., an uplink data channel such as a Physical Uplink Shared Channel (PUSCH) or a reference signal such as a Sounding Reference Signal (SRS). In the example of FIG. 1, the communication device 12 may transmit this second uplink control channel or signal 20B towards any one of TRP-1 . . . TRP-N or towards each of TRP-1 . . . TRP-N.

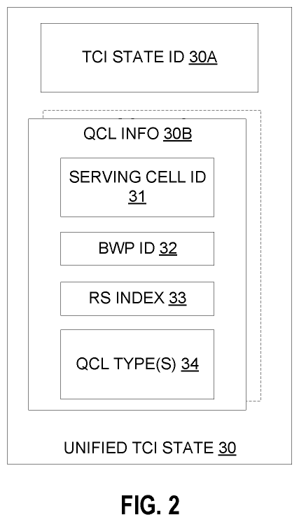

In this context, the communication device 12 is configured to employ a unified transmission configuration indication (TCI) state framework. A TCI state contains quasi co-location (QCL) information between antenna ports of the communication device 12. Two antenna ports are QCL if properties of the channel over which a transmission on one antenna port is conveyed can be inferred from the channel over which a transmission on the other antenna port is conveyed. That is, the communication device 12 can assume that properties of the channel over which a transmission on one antenna port is conveyed are the same as the properties of the channel over which a transmission on the other antenna port is conveyed. A TCI state therefore indicates a QCL relation or assumption between antenna ports, e.g., a source port and a target port. In a spatial relation TCI state framework, a TCI state applies to an individual channel or signal. In a unified TCI state framework, by contrast, a TCI state applies to multiple channels or signals. FIG. 2 shows one example of a unified TCI state 30, which as shown may consist of a TCI state identity (ID) 30A and one or more QCL information objects 30B, e.g., each of which may comprise a serving cell ID 31, a bandwidth part (BWP) ID 32, a reference signal (RS) index 33, and one or more QCL types 34.

Returning back to FIG. 1, multiple unified TCI states 16 are activated for the communication device 12. In one embodiment, for example, one unified TCI state is activated per TRP, e.g., for use in transmitting multiple uplink channels or signals towards that TRP. Activation of the multiple unified TCI states 16 as used herein means that the unified TCI states 16 are to be used by the communication device 12, e.g., for determining spatial filters for uplink transmissions.

As shown in FIG. 1, the multiple activated unified TCI states 16 may be activated via activation signaling 18 from the network node 14. The activation signaling 18 may for instance be Medium Access Control (MAC) signaling or physical layer signaling, e.g., a Downlink Control Information (DCI) message. In these and other embodiments, the communication network 10 may configure the wireless communication device 12 with multiple unified TCI states, e.g., via

Radio Resource Control (RRC) signaling, and then selectively activate multiple ones of those configured unified TCI states via the activation signaling 18, e.g., in the form of MAC signaling or physical layer signaling. Unified TCI state configuration in this case may take place on a semi-static basis whereas unified TCI state activation may take place on a more dynamic basis.

Some embodiments herein facilitate use of the unified TCI state framework in this context where the communication device 12 performs uplink transmissions towards multiple TRPs TRP-1 . . . TRP-N. To support such a scheme, the network node 12 configures with which of the multiple activated unified TCI states 16 each of one or more uplink channels or signals is associated. Some embodiments may thereby configure activated unified TCI state association per uplink channel or signal.

More particularly, the network node 14 transmits, to the communication device 12, a configuration 24 for each of one or more uplink channels or signals 20. The configuration(s) 24 may for instance be RRC configurations. Regardless, the configuration 24 for each of the one or more uplink channels or signals 20 indicates with which of the multiple activated unified TCI states 16 the uplink channel or signal 20 is associated. In some embodiments, this is explicit such that the configuration 24 for each of the one or more uplink channels or signals 20 explicitly indicates with which of the multiple activated unified TCI states 16 the uplink channel or signal 20 is associated.

For example, the communication device 12 as shown may receive a configuration 24-1 for a first uplink channel or signal 20A. In this case, the configuration 24-1 (explicitly) indicates with which of the multiple activated unified TCI states 16 the first uplink channel or signal 20A is associated. The configuration 24-1 may for instance indicate that the first uplink channel or signal 20A is associated with both activated unified TCI states 16-1 and 16-N. As another example, the communication device 12 as shown may also receive a configuration 24-M for a second uplink channel or signal 20B. In this case, the configuration 24-2 (explicitly) indicates with which of the multiple activated unified TCI states 16 the second uplink channel or signal 20B is associated. The configuration 24-2 may for instance indicate that the second uplink channel or signal 20B is associated with either only activated unified TCI state 16-1 or only activated unified TCI state 16-N.

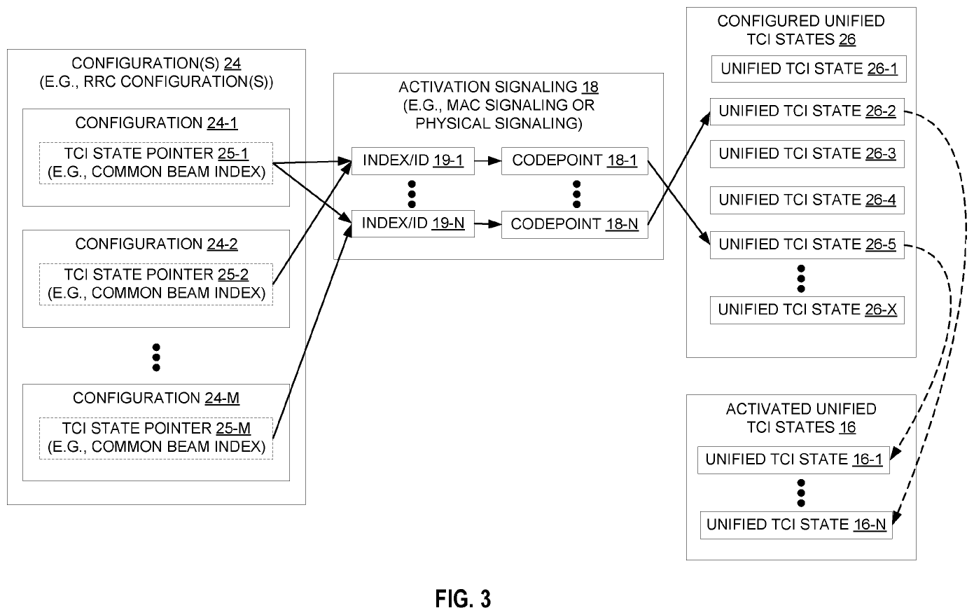

In some embodiments, the configuration 24 for each uplink channel or signal 20 exploits a TCI state pointer (e.g., a common beam index) that points to one or more of the activated unified TCI states 16 with which the uplink channel or signal 20 is associated. The TCI state pointer may for instance point to one or more activated unified TCI states 16 by pointing to one or more indices or identifiers that TCI state activation signaling 18 associates with those one or more activated unified TCI states 16. These and other embodiments may advantageously configure activated unified TCI state association as needed for multi-TRP uplink transmission, while minimizing signaling overhead. FIG. 3 shows an example in a context where the network node 14 first configures the communication device 12 with multiple unified TCI states and then selectively activate certain ones of the configured unified TCI states via activation signaling 18.

As shown in FIG. 3, the network node 14 configures the communication device 12 with X unified TCI states 26-1 . . . 26-X, e.g., via RRC signaling. The network node 14 may thereafter selectively activate certain ones of those configured unified TCI states 26 via activation signaling 18, e.g., in the form of MAC signaling or physical layer signaling. In this regard, the activation signaling 18 may include codepoints 18-1 . . . 18-N that indicate which of the configured unified TCI states 26 is to be activated. The activation signaling 18 also associates the multiple activated unified TCI states 16-1 . . . 16-N(which are indicated by the codepoints 18-1 . . . 18-N) with respective indices or identifiers (IDs) 19-1 . . . 19-N. For example, whatever unified TCI state is indicated as activated by codepoint 18-1 is associated with index or ID 19-1. And whatever unified TCI state is indicated as activated by codepoint 18-N is associated with index or ID 19-N.

In this context, the configuration 24 for each uplink channel or signal 20 is shown as including a TCI state pointer 25 (e.g., a common beam index). The TCI state pointer 25 included in the configuration 24 for each uplink channel or signal 20 points to one or more activated unified TCI states 16 by pointing to the one or more indices or identifiers 19 associated with the one or more activated unified TCI states 16. As shown, for example, the TCI state pointer 25-1 in the configuration 24-1 for a first uplink channel or signal (to be transmitted towards both TRP-1 and TRP-N) points to both activated unified TCI states 16-1 and 16-N by pointing to both indexes/identifiers 19-1 and 19-N. The TCI state pointer 25-2 in the configuration 24-2 for a second uplink channel or signal (to be transmitted towards only TRP-1) points to only the activated unified TCI state 16-1 by pointing to only index/identifier 19-1. And the TCI state pointer 25-M in the configuration 24-M for an Mth uplink channel or signal (to be transmitted towards only TRP-N) points to only the activated unified TCI state 16-N by pointing to only index/identifier 19-N.

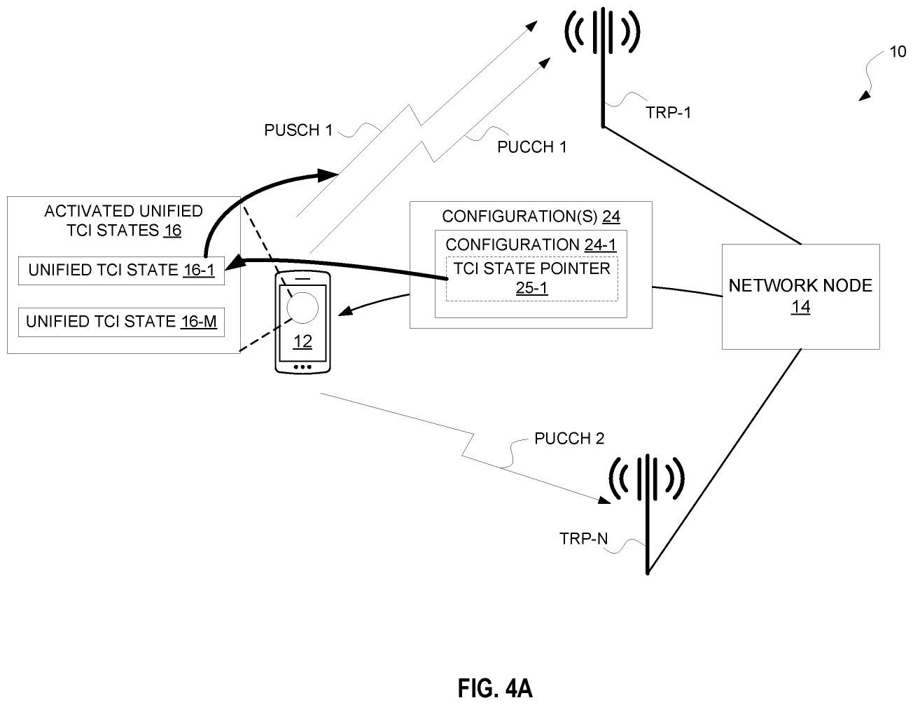

FIGS. 4A-4C show different possible examples for when the communication device 12 transmits PUCCH towards both TRP-1 and TRP-N. In this case, the communication device 12 determines a spatial filter for transmission of PUCCH towards TRP-1 using unified TCI state 16-1 and determines a spatial filter for transmission of PUCCH towards TRP-N using unified TCI state 16-N. As shown in FIG. 4A, in one example, a configuration 24-1 for PUSCH includes a TCI state pointer 25-1 that points to only activated unified TCI state 16-1, such that the communication device 12 determines a spatial filter for transmission of PUSCH only towards TRP-1 using unified TCI state 16-1 (without transmitting PUSCH towards TRP-N). By contrast, in the example of FIG. 4B, a configuration 24-1 for PUSCH includes a TCI state pointer 25-1 that points to only activated unified TCI state 16-N, such that the communication device 12 determines a spatial filter for transmission of PUSCH only towards TRP-N using unified TCI state 16-N(without transmitting PUSCH towards TRP-1). And, in yet another example of FIG. 4C, a configuration 24-1 for PUSCH includes a TCI state pointer 25-1 that points to both activated unified TCI states 16-1 and 16-N, such that the communication device 12 determines a spatial filter for transmission of PUSCH towards TRP-1 using unified TCI state 16-1 and determines a spatial filter for transmission of PUSCH towards TRP-N using unified TCI state 16-N.

Some embodiments herein are applicable in the following context, where the communication device 12 is exemplified as a user equipment (UE).

In particular, some embodiments herein are applicable to the next generation mobile wireless communication system (5G) or new radio (NR), which will support a diverse set of use cases and a diverse set of deployment scenarios. The later includes deployment at both low frequencies (below 6 GHZ) and very high frequencies (up to 10's of GHZ).

### NR Frame Structure and Resource Grid

NR uses CP-OFDM (Cyclic Prefix Orthogonal Frequency Division Multiplexing) in both downlink (i.e., from a network node, gNB, or base station, to a user equipment or UE) and uplink (i.e., from UE to gNB). Discrete Fourier Transform (DFT) spread OFDM is also supported in the uplink. In the time domain, NR downlink and uplink are organized into equally-sized subframes of 1 ms each. A subframe is further divided into multiple slots of equal duration. The slot length depends on subcarrier spacing. For subcarrier spacing of Δf=15 kHz, there is only one slot per subframe and each slot consists of 14 OFDM symbols.

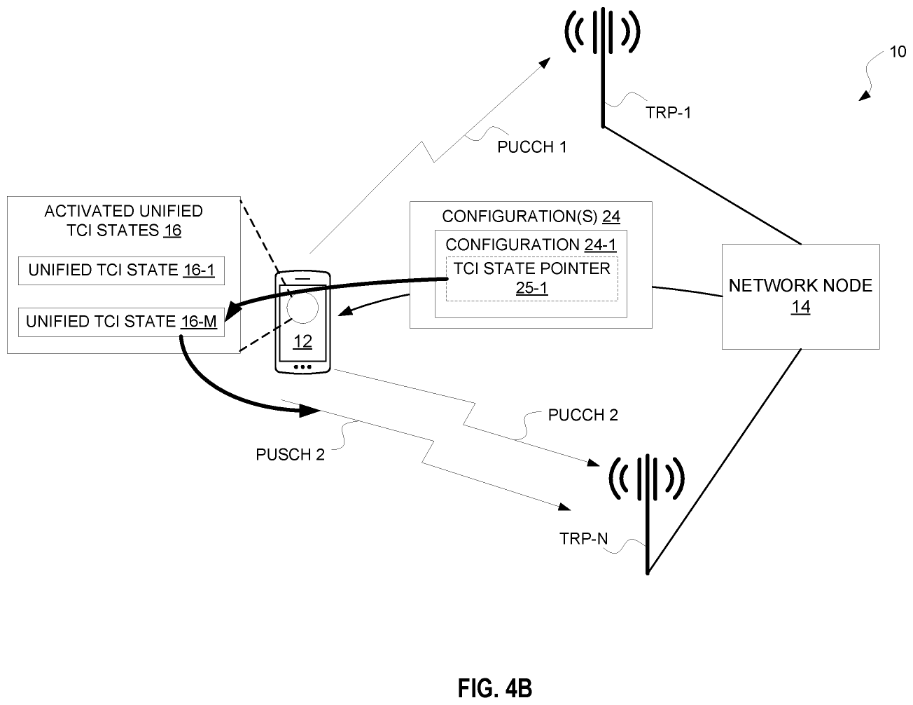

Data scheduling in NR is typically in slot basis, an example is shown in FIG. 5 with a 14-symbol slot, where the first two symbols contain physical downlink control channel (PDCCH) and the rest contains physical shared data channel (PDCH), either PDSCH (physical downlink shared channel) or PUSCH (physical uplink shared channel).

Different subcarrier spacing values are supported in NR. The supported subcarrier spacing values (also referred to as different numerologies) are given by Δf=(15×2^{μ}) kHz where μ∈0,1,2,3,4. Δf=15 kHz is the basic subcarrier spacing. The slot durations at different subcarrier spacings is given by ½^{μ} ms.

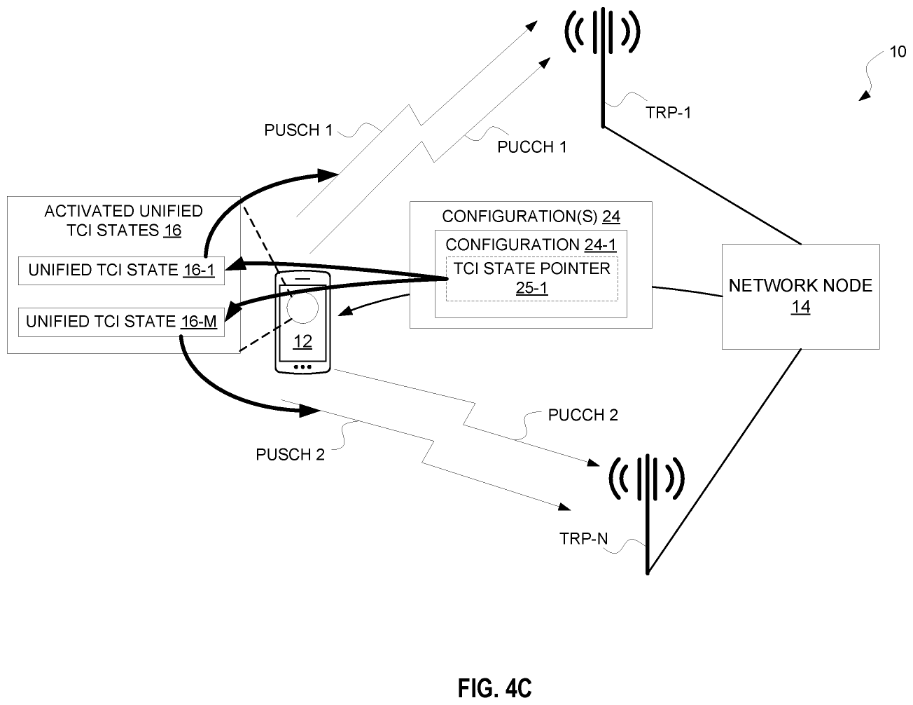

In the frequency domain, a system bandwidth is divided into resource blocks (RBs), each corresponding to 12 contiguous subcarriers. The RBs are numbered starting with 0 from one end of the system bandwidth. The basic NR physical time-frequency resource grid is illustrated in FIG. 6, where only one resource block (RB) within a 14-symbol slot is shown. One OFDM subcarrier during one OFDM symbol interval forms one resource element (RE).

Downlink and uplink transmissions can be either dynamically scheduled in which the gNB transmits a downlink (DL) assignment or an uplink grant via downlink control information (DCI) over PDCCH (Physical Downlink Control Channel) to a UE for each PDSCH or PUSCH transmission, or semi-persistent scheduled (SPS) in which one or more DL SPS or UL configured grants (CGs) are semi-statically configured and each can be activated or deactivated by a DCI.

### CORESET and Search Space

In some embodiments, a UE monitors a set of PDCCH candidates for potential PDCCHs. A PDCCH candidate consists of L∈[1,2,4,8,16] control-channel elements (CCEs) in a Control Resource Set (CORESET). A CCE consists of 6 resource-element groups (REGs) where a REG equals one RB during one OFDM symbol. L is referred to as the CCE aggregation level.

The set of PDCCH candidates is defined in a PDCCH search space (SS) set. An SS set can be a Common Search Space (CSS) set or a UE Specific Search Space (USS) set. A UE can be configured with up to 10 SS sets per bandwidth part (BWP) for monitoring PDCCH candidates.

Each SS set is associated with a CORESET. A CORESET consists of N_{RB}^{CORESET} resource blocks in frequency domain and N_{symb}^{CORESET}∈{1,2,3} consecutive OFDM symbols in time domain. In NR Rel-15, a UE can be configured with up to 3 CORESETs per BWP.

For each SS set, a UE is configured with the following parameters comprising:
a search space set index s, 0≤s<40
an association between the search space set s and a CORESET p
a PDCCH monitoring periodicity of kₛ slots and a PDCCH monitoring offset of oₛ slots
a PDCCH monitoring pattern within a slot, indicating first symbol(s) of the CORESET within a slot for PDCCH monitoring
a duration of Tₛ<kₛ slots indicating a number of slots that the search space set exists
a number of PDCCH candidates Mₛ^{(L)} per CCE aggregation level L
an indication that search space set s is either a CSS set or a USS set
DCI formats to monitoring

A UE determines a PDCCH monitoring occasion on an active DL BWP from the PDCCH monitoring periodicity, the PDCCH monitoring offset, and the PDCCH monitoring pattern within a slot. For search space set s, the UE determines that a PDCCH monitoring occasion(s) exists in slot n_{s,f}^{μ} in frame n_{f} if (n_{f}·Nₛₗₒₜ^{frame,μ}+n_{s,f}^{μ}−oₛ) mod kₛ=0, where Nₛₗₒₜ^{frame,μ} is the number of slots per radio frame. The UE monitors PDCCH candidates for search space set s for Tₛ consecutive slots, starting from slot n_{s,f}^{μ}, and does not monitor PDCCH candidates for search space set s for the next kₛ−Tₛ consecutive slots.

### TCI States and QCL

In some embodiments, a Transmission Configuration Indication (TCI) state contains Quasi Co-location (QCL) information between two antenna ports. Two antenna ports are said to be QCL if certain channel parameters associated with one of the two antenna ports can be inferred from the other antenna port. An antenna port is defined by a reference signal (RS). Therefore, a TCI state is used in NR to indicate the QCL relation between a source RS and a target RS. The source RS can be one of a NZP CSI-RS (Non-zero Power Channel State Information Reference Signal), tracking RS (TRS), and a SSB (Synchronization Signal Block), while the target RS can be a Demodulation Reference Signal (DMRS) for PDCCH or PDSCH, or a CSI-RS.

Some embodiments apply to the supported QCL information types in NR which include:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

A list of TCI states can be RRC configured in a higher layer parameter PDSCH-Config information element (IE) (see 3GPP TS 38.331 v16.7.0 section 6.3.2 for details). In some embodiments, e.g., using a 3-stage approach, up to 8 TCI states from the list can be activated with a MAC Control Element (CE). In NR Rel-15, one TCI state is activated by a MAC CE for each TCI codepoint of a TCI field in DCI, where up to 8 TCI codepoints can be supported (see 3GPP TS 38.321 v15.12.0 section 6.1.3.14 for details). In NR Rel-16, up to two TCI states can be activated by a MAC CE for each TCI codepoint (see 3GPP TS 38.321 v16.7.0 section 6.1.3.24). For dynamically scheduled PDSCH, one of the TCI codepoints is indicated in the TCI field of the DCI (DCI format 1_1 or DCI format 1_2) scheduling the PDSCH for PDSCH reception. For example, if a SSB or CSI-RS is configured as the QCL-typeD source RS in an activated TCI state indicated to a PDSCH, the same receive beam (or spatial filter) for receiving the SSB or CSI-RS would be used by a UE to receive the PDSCH.

For each CORESET, a list of TCI states can be RRC configured, and one of the TCI states is activated by a MAC CE. For example, if an SSB is configured as the QCL-typeD source RS in an activated TCI state for a CORESET, the same receive beam for receiving the SSB can be used by a UE to receive PDCCHs transmitted in the CORESET.

Beam Management with Unified TCI Framework

In NR, downlink beam management is performed by conveying spatial QCL (‘Type D’) assumptions to the UE through TCI states. Without unified TCI states, such a framework allows great flexibility for the network to instruct the UE to receive signals from different spatial directions in DL with a cost of large signaling overhead and slow beam switch. These limitations are particularly noticeable and costly when UE movement is considered. One example is that beam update using DCI can only be performed for PDSCH, and MAC-CE and/or RRC is required to update the beam for other reference signals/channels, which may cause extra overhead and latency. Furthermore, in a majority of cases, the network transmits to and receives from a UE in the same direction for both data and control. Hence, using separate frameworks (TCI state respective spatial relations) for different channels/signals complicates the implementations.

Some embodiments herein thereby exploit unified TCI states, e.g., as specified by 3GPP. In particular, some embodiments herein support unified TCI states as specified according to 3GPP Rel-17. In Rel-17, a unified TCI state based beam indicated framework was introduced to simplify beam management in frequency range 2 (FR2), in which a common beam represented by a TCI state may be activated/indicated to a UE, and the common beam is applicable for multiple channels/signals such as PDCCH and PDSCH. The common beam framework is also referred to a unified TCI state framework. A TCI state configured under the Rel-17 framework exemplifies a unified TCI state according to some embodiments herein.

In some embodiments, the unified TCI state framework can be RRC configured in one out of two modes of operation, i.e., Joint DL/UL TCI” or “Separate DL/UL TCI”. For “Joint DL/UL TCI”, one common Joint TCI state is used for both DL and UL signals/channels. For “Separate DL/UL TCI”, one common DL-only TCI state is used for DL channels/signals and one common UL-only TCI state is used for UL signals/channels.

In some embodiments, a unified TCI state for separate DL/UL or Joint DL/UL comprises identifiers of two QCL source reference signals as shown below, where the first RS is a QCL source RS for one of {typeA, typeB, typeC} QCL types, while the second RS is a QCL source RS for QCL typeD. The second RS is used to indicate a spatial beam or filter associated with the unified TCI state. An example ASN.1 code for configuring separate UL/DL or Joint DL/UL TCI state is shown below.

| | |
|---|---|
| DLorJoint-TCIState-r17 ::= | SEQUENCE { |
| tci-StateUnifiedId-r17 | DLorJoint-TCIState-Id-r17, |
| tci-StateType-r17 | ENUMERATED {DLOnly, JointULDL}, |
| qcl-Type1-r17 | QCL-Info, |
| qcl-Type2-r17 | QCL-Info OPTIONAL -- Need R |

}

| | |
|---|---|
| QCL-Info ::= | SEQUENCE { |
| cell | ServCellIndex OPTIONAL, -- Need R |
| bwp-Id | BWP-Id OPTIONAL, -- Cond CSI-RS-Indicated |
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, typeD}, |

...,

In some embodiments, a unified TCI state can be updated in a similar way as the TCI state update for PDSCH in Rel-15/16, i.e., with one of two alternatives. In a “two-stage” alternative, RRC signaling is used to configure a number of unified TCI states in higher layer parameter PDSCH-config, and a MAC-CE is used to activate one of unified TCI states. In some embodiments, then, the activated unified TCI states 16 in FIG. 1 are exemplified as any unified TCI states activated via a MAC-CE. In a “three-stage” alternative, RRC signaling is used to configure a number of unified TCI states in PDSCH-config, a MAC-CE is used to activate up to 8 unified TCI states, and a 3-bit TCI state bitfield in DCI is used to indicate one of the activate unified TCI states. In some embodiments, then, the activated unified TCI states 16 in FIG. 1 are exemplified as any unified TCI states that are both activated via a MAC-CE and indicated via a DCI. In this case, then, bare “activation” of a unified TCI state via MAC-CE must follow the “indication” of that unified TCI state via DCI in order for the communication device 12 to be configured to use that unified TCI state.

An activated or indicated unified TCI state will be used in subsequent PDCCH, PDSCH, and NZP CSI-RS transmissions until a new unified TCI state is activated or indicated.

In the following description, then, an “activated/indicated” unified TCI state (also referred to as an “activated or indicated” unified TCI state) exemplifies an “activated” unified TCI state as referred to in FIG. 1.

In some embodiments, the existing DCI formats 1_1 and 1_2, as specified in 38.212 version 17.0.0 are reused for beam indication (i.e., TCI state indication/update), both with and without DL assignment. For DCI formats 1_1 and 1_2 with DL assignment, ACK/NACK of the PDSCH can be used as indication of successful reception of beam indication. For DCI formats 1_1 and 1_2 without DL assignment, a new ACK/NACK mechanism analogous to that for SPS PDSCH release with both type-1 and type-2 HARQ-ACK codebook is used, where upon a successful reception of the beam indication DCI, the UE reports an ACK.

In some embodiments, for DCI-based beam indication, the first slot to apply the indicated TCI is at least Y symbols after the last symbol of the acknowledgment of the joint or separate DL/UL beam indication. The Y symbols are configured by the gNB based on UE capability, which is also reported in units of symbols

### Multi-TRP PDCCH Repetition

Some embodiments herein are applicable for PDCCH repetition, e.g., as in NR Rel-17, which provides for more robust PDCCH reception in which a PDCCH is transmitted over two transmission and reception points (TRPs) on different time or frequency resources.

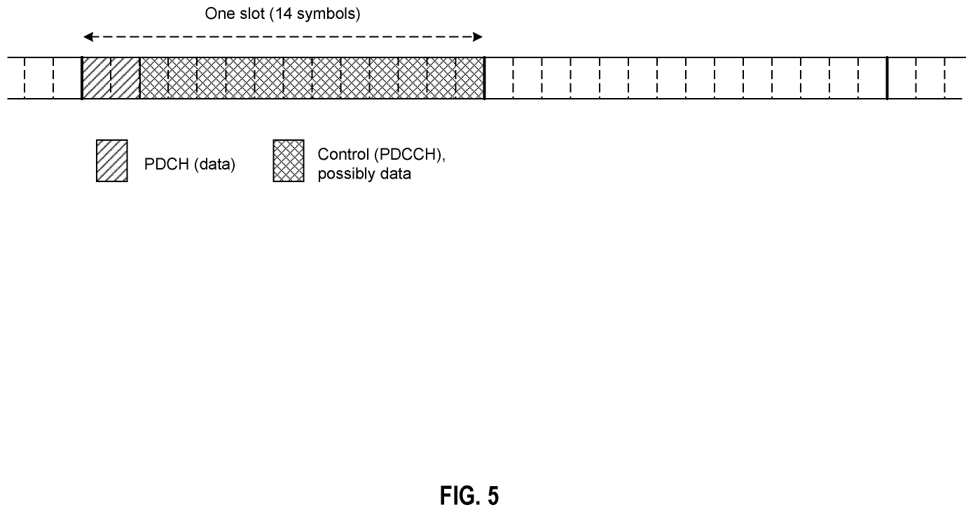

An example is shown in FIG. 7, where a PDCCH is repeated over two TRPs at different times. The 1^{st} PDCCH repetition is sent in a PDCCH candidate in CORESET #c1 associated with synchronization signal (SS) set #s1 and the second PDCCH repetition is sent in another PDCCH candidate in CORESET #c2 associated with SS set #s2, where SS sets #s1 and #s2 are linked. Each of CORESET #c1 and CORESET #c2 are activated with a transmission configuration indicator (TCI) state associated with the respective TRP.

Two linked SS sets need to be configured with the same set of parameters such as periodicity, slot offset, number of monitoring occasions within a slot, etc. For a given CCE aggregation level and two linked SS sets, the location of one PDCCH candidate in one SS set can be obtained from a PDCCH candidate in the other SS set. When performing PDCCH detection, a UE may detect PDCCH individually in each PDCCH candidate or jointly by soft combining of the two PDCCH candidates.

### SFN PDCCH

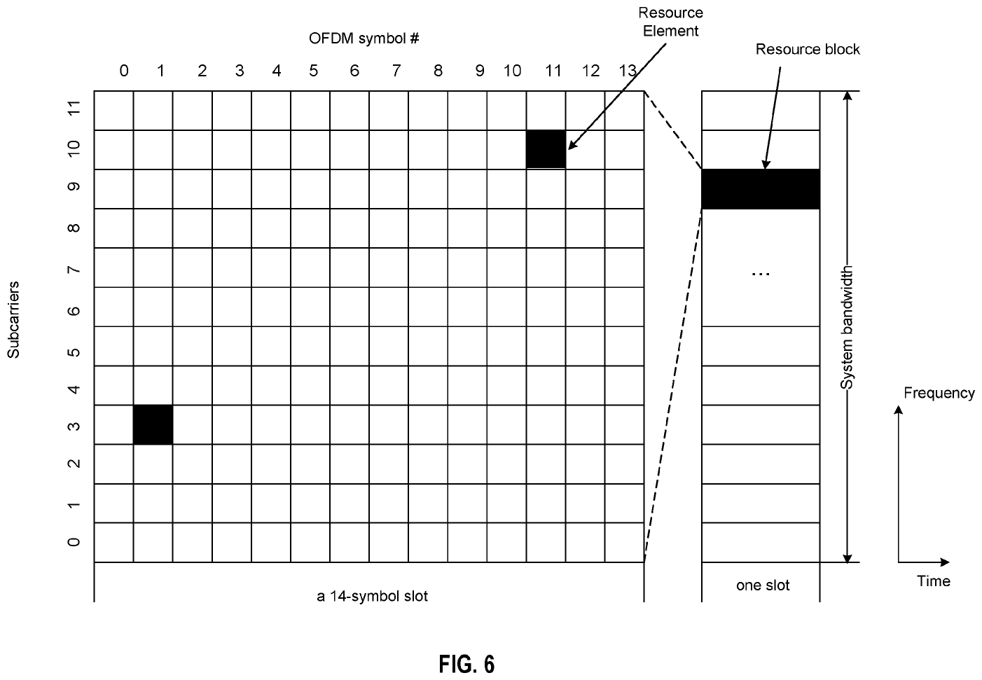

Some embodiments herein are applicable for single frequency network (SFN) based PDCCH, e.g., as in NR Rel-17, for more robust PDCCH reception in which a PDCCH is transmitted simultaneously from two TRPs in the same time and frequency resource. An example is shown in FIG. 8, where a single CORESET and the associated SS set are associated to both TRPs. This is indicated to a UE by both a RRC configuration of SFN PDCCH and a CORESET activated with two TCI states.

Multi-TRP (mTRP) PDSCH Schemes

Some embodiments herein are applicable for PDSCH transmission over two TRPs, e.g., as introduced in NR Rel-16, including a non-coherent joint transmission (NC-JT) scheme, two frequency domain multiplexing (FDM) schemes, and two time domain multiplexing (TDM) schemes. In these multi-TRP PDSCH schemes, each TRP is represented by an indicated TCI state. In NC-JT, a PDSCH is transmitted over two TRPs in the same time and frequency resource with different multiple-input multiple-output (MIMO) layers of the PDSCH transmitted from different TRPs. For example, 2 layers can be transmitted from a first TRP and 1 layer can be transmitted from a second TRP for a total of 3 layers. For NC-JT based PDSCH scheduling, two TCI states are indicated in a TCI codepoint of DCI scheduling the PDSCH. The demodulation reference signal (DMRS) ports in a first and second code division multiplexing (CDM) groups are associated with the first and second TCI states, respectively.

In the FDM schemes, different frequency domain resources of a PDSCH are allocated to different TRPs. In FDM scheme A, a single PDSCH is transmitted and part of the PDSCH is sent from one TRP and the rest from the other TRP. In FDM scheme B, a PDSCH is repeated over two TRPs. For FDM based multi-TRP PDSCH scheduling, two TCI states are indicated in a TCI codepoint of DCI scheduling the PDSCH. The DMRS ports in a first and second set of scheduled resource blocks (RBs) are associated with the first and second TCI states, respectively.

In the TDM schemes, a PDSCH is repeated in multiple times, each over one of two TRPs. In TDM scheme A, a PDSCH is repeated two times within a slot, one from each TRP. While in TDM scheme B (or slot-based TDM scheme), a PDSCH is repeated in consecutive slots, either in a cyclic manner from two TRPs in which the PDSCH is transmitted alternatively from a first TRP in one slot and a second TRP in the next slot, or in a sequential manner in which PDSCH is transmitted alternatively from the first and second TRPs every two consecutive slots. For TDM based multi-TRP PDSCH scheduling, two TCI states are indicated in a TCI codepoint of DCI scheduling the PDSCH. The DMRS ports in a first and second set of PDSCH transmission occasions are associated with the first and second TCI states, respectively. The first and second set of PDSCH transmission occasions are determined according to the mapping type, i.e., cyclic or sequential mapping.

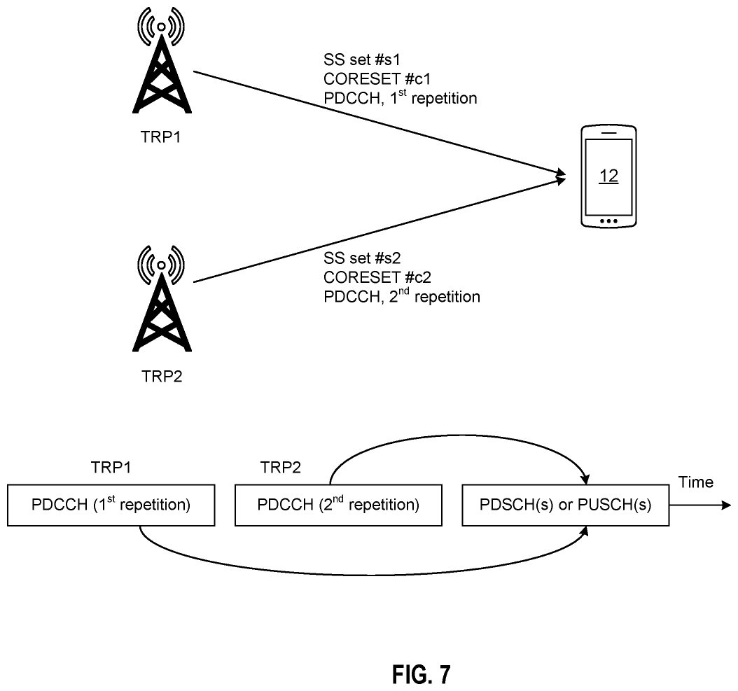

An example of TDM Scheme B is shown in FIG. 9, where 4 PDSCH repetitions are scheduled from two TRPs. In case of cyclic mapping, the 1^{st} and 3^{rd} PDSCH occasions are associated with the 1^{st} TCI state, and the 2^{nd} and 4^{th} PDSCH occasions are associated with the 2^{nd} TCI state indicated in the DCI. In case of sequential mapping, the 1^{st} and 2^{nd} PDSCH occasions are associated with the 1^{st} TCI state and the 3^{rd} and 4^{th} PDSCH occasions are associated with the 2^{nd} TCI state indicated in the DCI.

### UL Transmission to Multiple Transmission Points (TRPs)

Some embodiments herein are applicable for PDSCH transmission with multiple transmission points, e.g., as has been introduced in 3GPP for NR Rel-16, in which a transport block may be transmitted over multiple TRPs to improve transmission reliability.

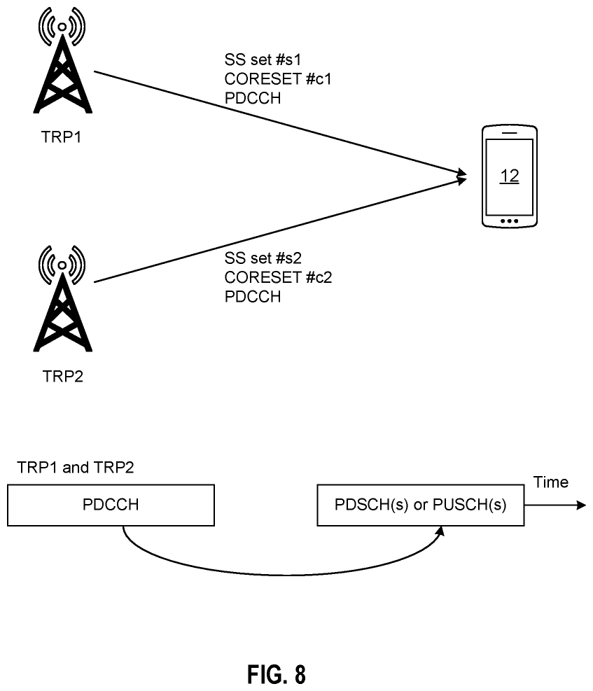

In some embodiments, UL enhancement with multiple TRPs is performed by transmitting a PUCCH or PUSCH towards to different TRPs as shown in FIG. 10, in different times (either in different slots or in different sets of symbols within a slots, also known sometimes referred to as subslot or mini-slot).

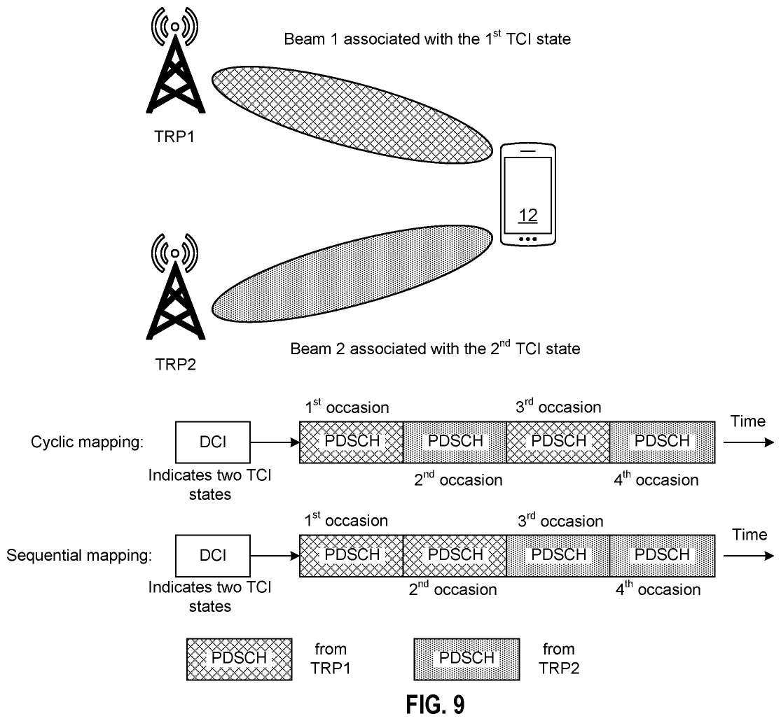

In one scenario, multiple PUCCH/PUSCH transmissions, each towards a different TRP, may be scheduled by a single DCI. For example, multiple spatial relations (i.e., spatial beams) may be activated for a PUCCH resource and the PUCCH resource may be signaled in a DCI scheduling a PDSCH. The hybrid automatic repeat request (HARQ) ack/nack (A/N) associated with the PDSCH is then carried by the PUCCH which is then repeated multiple times either within a slot or over multiple slots, each repetition is towards a different TRP. An example is shown in FIG. 11, where a PDSCH is scheduled by a DCI and the corresponding HARQ A/N is sent in a PUCCH which is repeated twice in time, one towards TRP #1 and the other towards TRP #2. Each TRP is associated with a PUCCH spatial relation.

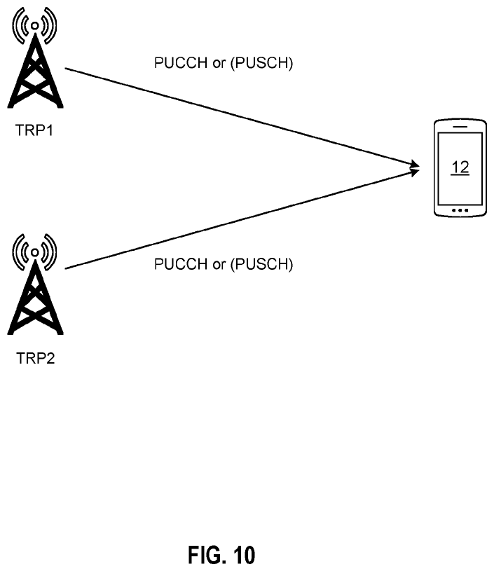

An example of PUSCH repetitions is shown in FIG. 12, where two PUSCH repetitions for a same TB are scheduled by a single DCI. Each PUSCH occasion is transmitted towards a different TRP. Each TRP is associated with a status report indication (SRI) signaled in DCI. In the spatial relation TCI state framework, the spatial transmit filter(s) used to transmit PUSCH repetitions towards a given TRP are provided by the corresponding SRI.

### CSI-RS

A Channel State Information Reference Signal (CSI-RS) according to some embodiments herein is used, e.g., as specified in NR, for channel state information, CSI, measurement in the downlink. A CSI-RS is transmitted on an antenna port at the gNB and is used by a UE to measure downlink channel associated with the antenna port. CSI-RS for this purpose is also referred to as Non-Zero Power (NZP) CSI-RS. The antenna port is also referred to as a CSI-RS port. In some embodiments, the supported number of CSI-RS ports in a CSI-RS resource in NR can be one of {1,2,4,8, 12,16,24,32}. Multiple CSI-RS resources can be configured. A CSI-RS resource set can contain one or more CSI-RS resources.

A CSI-RS resource can be aperiodic, periodic, or semi-persistent (SP). CSI-RS resources in a CSI-RS resource set are transmitted together and have the same time domain configuration, i.e., aperiodic, periodic or semi-persistent.

In some embodiments, aperiodic CSI-RS transmission is triggered by one of DCI format 0_1 or DCI format 0_2. SP CSI-RS transmission is activated and deactivated by a MAC CE.

In frequency range 2 (FR2), each CSI-RS resource is also associated with a beam which is specified by a QCL source reference signal (RS) with type D. For periodic, the QCL source RS is RRC configured. For Aperiodic CSI-RS, the QCL type D source RS is configured in an associated aperiodic CSI trigger state, where the index of the trigger state is indicated in the DCI triggering the aperiodic CSI-RS. For SP CSI-RS, the QCL source RS is indicated in the corresponding activation MAC CE. These are further explained below.

### QCL Configuration for Aperiodic CSI-RS Resources

A “CSI-Aperiodic TriggerStateList” information element (IE) defined in 3GPP TS 38.331 is used in NR to configure a UE with a list of aperiodic CSI trigger states, each defined by the parameter “CSI-AperiodicTriggerState”, as shown below. Each codepoint of the “CSI request” field in DCI (DCI format 1_1, or DCI format 1_2) is associated with one of the trigger states in the list, e.g., as described in 3GPP TS 38.214 17.0.0 section 5.2.1.5.1. Upon reception of a DCI with a CSI request codepoint indicating a trigger state, the UE receives NZP CSI-RS resources in a NZP CSI-RS resource set indicated by the parameter “resourceset” in the trigger state according the QCL information configured by the parameter “qcl-info”. The QCL information contains a TCI state ID for each NZP CSI-RS resources in the NZP CSI-RS resource set.

CSI-Aperiodic TriggerStateList information element

```
  -- ASN1START
  -- TAG-CSI-APERIODICTRIGGERSTATELIST-START
  CSI-AperiodicTriggerStateList ::= SEQUENCE (SIZE (1..maxNrOfCSI-
AperiodicTriggers)) OF CSI-AperiodicTriggerState
  CSI-AperiodicTriggerState ::= SEQUENCE {
    associatedReportConfigInfoList SEQUENCE
(SIZE(1..maxNrofReportConfigPerAperiodicTrigger)) OF CSI-AssociatedReportConfigInfo,
    ...
  }
  CSI-AssociatedReportConfigInfo ::= SEQUENCE {
```

| | |
|---|---|
| reportConfigId | CSI-ReportConfigId, |
| resourcesForChannel | CHOICE { |
| nzp-CSI-RS | SEQUENCE { |
| resourceSet | INTEGER (1..maxNrofNZP-CSI-RS- |
| | ResourceSetsPerConfig), |
| qcl-info | SEQUENCE (SIZE(1..maxNrofAP-CSI-RS- |
| | ResourcesPerSet)) OF TCI-StateId |
| | OPTIONAL -- Cond Aperiodic |

},

| | |
|---|---|
| csi-SSB-ResourceSet | INTEGER (1..maxNrofCSI-SSB- |
| | ResourceSetsPerConfig) |

},

| | |
|---|---|
| csi-IM-ResourcesForInterference | INTEGER(1..maxNrofCSI-IM- |
| | ResourceSetsPerConfig) |
| | OPTIONAL, -- Cond CSI-IM-ForInterference |

nzp-CSI-RS-ResourcesForInterference INTEGER (1..maxNrofNZP-CSI-RS-

```
        ResourceSetsPerConfig)
        OPTIONAL, -- Cond NZP-CSI-RS-
        ForInterference
```

```
    ...
  }
  -- TAG-CSI-APERIODICTRIGGERSTATELIST-STOP
  -- ASN1STOP
```

### QCL Information for SP CSI-RS Resources

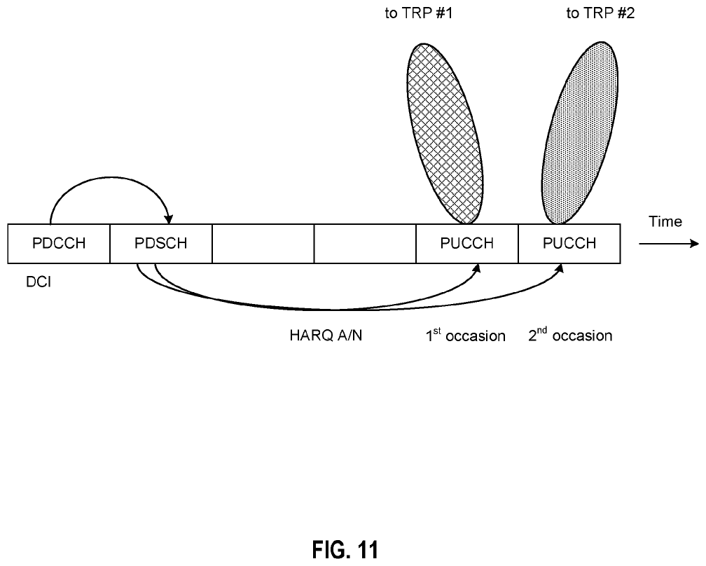

In some embodiments, QCL information for a SP CSI-RS resource in a CSI-RS resource set is indicated in the corresponding MAC CE activating the CSI-RS resource set. The MAC CE may for example be as otherwise described in TS 38.321 v16.7.0 section 6.1.3.12 and FIG. 6.1.3.12-1, which is reproduced in FIG. 13.

As shown in FIG. 13, a TCI state ID is indicated for each CSi-RS resource in the SP CSI-RS resource set. The meaning of each field is as follows.

A/D: This field indicates whether to activate or deactivate indicated SP CSI-RS and CSI-IM resource set(s). The field is set to 1 to indicate activation, otherwise it indicates deactivation.

Serving Cell ID: This field indicates the identity of the Serving Cell for which the MAC CE applies. The length of the field is 5 bits.

BWP ID: This field indicates a DL BWP for which the MAC CE applies as the codepoint of the DCI bandwidth part indicator field as specified in TS 38.212 v17.0.0. The length of the BWP ID field is 2 bits.

SP CSI-RS resource set ID: This field contains an index of NZP-CSI-RS-ResourceSet containing Semi Persistent NZP CSI-RS resources, as specified in TS 38.331 v16.7.0, indicating the Semi Persistent NZP CSI-RS resource set, which shall be activated or deactivated. The length of the field is 6 bits.

Interference management (IM): This field indicates the presence of the octet containing SP CSI-IM resource set ID field. If the IM field is set to 1, the octet containing SP CSI-IM resource set ID field is present. If IM field is set to 0, the octet containing SP CSI-IM resource set ID field is not present.

SP CSI-IM resource set ID: This field contains an index of CSI-IM-ResourceSet containing Semi Persistent CSI-IM resources, as specified in TS 38.331 v16.7.0, indicating the Semi Persistent CSI-IM resource set, which shall be activated or deactivated. The length of the field is 6 bits.

TCI State IDᵢ: This field contains TCI-StateId, as specified in TS 38.331 v16.7.0, of a TCI State, which is used as QCL source for the resource within the Semi Persistent NZP CSI-RS resource set indicated by SP CSI-RS resource set ID field. TCI State ID₀ indicates TCI State for the first resource within the set, TCI State ID₁ for the second one and so on. The length of the field is 7 bits. If the A/D field is set to 0, the octets containing TCI State ID field(s) are not present.

R: Reserved bit, set to 0.

Some embodiments herein address certain challenge(s) in this context. In particular, as of NR Rel-17, the unified TCI state framework supported activation or indication of only a single unified TCI state at each time. Thus, in NR Rel-17, it is only applicable to PUSCH data transmissions from a UE towards a single TRP. The mTRP PUSCH schemes supported in Rel-17 are not supported by the unified TCI framework introduced in Rel-17 (i.e., the mTRP PUSCH schemes introduced in Rel-17 rely on the Rel-15 spatial relation framework). NR Rel-18 extends the unified TCI state framework to support mTRP schemes. To support mTRP PUSCH schemes, multiple unified TCI states need to be activated/indicated to the UE. How to associate PUSCH transmission to one or more of the multiple unified TCI states is heretofore an open problem.

Some embodiments herein accordingly include solutions on how to determine spatial filters for PUSCH transmissions for mTRP operation for the unified TCI state framework using explicitly configured common beam indexes. In doing so, some embodiments advantageously provide a simple way to associate a PUSCH transmission to one or more common beams for multi-TRP based transmission under a unified TCI state framework.

In the following embodiments, the term ‘common beam index’ is used. A common beam index can be understood to be an identifier or ID of an activated/indicated Joint DL/UL TCI state. In some other cases, a common beam index can be understood to be an identifier or ID of an activated/indicated Separate UL TCI state (i.e., UL-only TCI state). Although most of the embodiments below are written with respect to Joint DL/UL TCI state, the embodiments are non-limiting and are equally valid when Separate UL TCI state is activated/indicated in place of Joint DL/UL TCI state. A common beam index may thereby generally exemplify a TCI state pointer according to some embodiments.

### Embodiments where Common Beam Indexes are Configured in PUSCH Config

In one embodiment, one or two common beam indexes can be explicitly configured in PUSCH-config (as otherwise specified in TS 38.331 v16.7.0) as schematically illustrated below:

-- ASN1START
-- TAG-PUSCH-CONFIG-START

| | |
|---|---|
| PUSCH-Config ::= | SEQUENCE { |

[[
Common_beam_index

ENUMERATED {commonBeam1,
commonBeam2,commonBeam1ANDcommonBeam2}

]]
-- TAG-PUSCH-CONFIG-STOP
-- ASN1STOP

In one other embodiment, instead of configuring the explicit common beam index in PUSCH-config, it can be configured in PUSCH-ServingCellConfig.

PUSCH-config and/or PUSCH-ServingCellConfig serve as examples of configuration(s) 24 in FIG. 1, e.g., when the one or more uplink channels or signals 20 includes one or more PUSCH channels.

In one embodiment, in case the Common_beam_index is configured with commonBeam1 and the UE is indicated with two Joint DL/UL TCI states, the UE should determine the spatial filter for the PUSCH transmission based on a first indicated Joint DL/UL TCI state. In a similar way, in case the Common_beam_index is configured with commonBeam2 and the UE is indicated with two Joint DL/UL TCI states, the UE should determine the spatial filter for the PUSCH transmission based on a second indicated Joint DL/UL TCI state. And in case the Common_beam_index is configured with commonBeam1ANDcommonBeam2 and the UE is indicated with two Joint DL/UL TCI states, the UE should determine the spatial filter for a first PUSCH transmission based on a first indicated Joint DL/UL TCI state and a second PUSCH transmission based on a second Joint DL/UL TCI state.

In one embodiment, in case the UE is only indicated with one Joint DL/UL TCI state, the UE shall ignore this field, and follow the indicated Joint DL/UL TCI state.

In another embodiment, a common_beam_index may only be configured in one PUSCH-Config corresponding to a given UL dedicated BWP and a serving cell (i.e., a component carrier). This given UL dedicated BWP and serving cell may be referred to as the reference PUSCH-Config. For the other PUSCH-Config's that should follow the same common_beam_index as configured in the reference PUSCH-Config, at least one identifier may be configured in the other PUSCH-Config's.

Consider the following example. In this example, PUSCH-Config 0 in BWP 0 of Serving cell 1 is configured with a common_beam_index. And PUSCH-Config 1 in BWP 1 of Serving cell 2 is not configured with a common_beam_index, but configured with the identifiers of the reference PUSCH-Config which consists of IDs corresponding to BWP 0 and/or Serving cell 1

In the above example embodiment, if the Common_beam_index is configured with commonBeam1 in PUSCH-Config 0 and the UE is indicated with two Joint DL/UL TCI states, then for PUSCH transmission corresponding to PUSCH-Config 1, the UE should determine the spatial filter for the PUSCH transmission based on a first indicated Joint DL/UL TCI state (i.e., the same assumption as the reference PUSCH-Config).

Similarly, if the Common_beam_index is configured with commonBeam2 in PUSCH-Config 0 and the UE is indicated with two Joint DL/UL TCI states, then for PUSCH transmission corresponding to PUSCH-Config 1, the UE should determine the spatial filter for the PUSCH transmission based on a second indicated Joint DL/UL TCI state (i.e., the same assumption as the reference PUSCH-Config).

If the Common_beam_index is configured with commonBeam1ANDcommonBeam2 in PUSCH-Config 0 and the UE is indicated with two Joint DL/UL TCI states, then for PUSCH transmission corresponding to PUSCH-Config 1, the UE should determine the spatial filter for a first PUSCH transmission based on a first indicated Joint DL/UL TCI state and a second PUSCH transmission based on a second Joint DL/UL TCI state (i.e., the same assumption as the reference PUSCH-Config).

The benefit of the above embodiment is that when the common_beam_index needs to be updated, it is sufficient that the common_beam_index in the reference PUSCH-Config is updated via reconfiguration. No such update/reconfiguration is needed for the non-reference PUSCH-Config's (i.e., PUSCH-Config's that follow the same common_beam_index assumption as the reference PUSCH-Config).

A configuration example of the reference PUSCH-Config is shown below. In this example, the parameter ‘refCommon_beam_index’ provides the reference PUSCH-Config (i.e., the serving cell and the BWP ID corresponding to the PUSCH-Config that contains the configured Common_beam_index). Note that if a PUSCH-Config is configured with Common_beam_index, then refCommon_beam_index is not configured for that PUSCH-Config (i.e., that PUSCH-Config will be reference PUSCH-Config for other PUSCH-Config's). For a non-reference PUSCH-Config, only refCommon_beam_index will be configured, and Common_beam_index will not be configured).

-- ASN1START
-- TAG-PUSCH-CONFIG-START

| | |
|---|---|
| PUSCH-Config ::= | SEQUENCE { |

[[

| | |
|---|---|
| Common_beam_index | ENUMERATED {commonBeam1, |
| | commonBeam2,commonBeam1ANDcommonBeam2} |
| | OPTIONAL -- Need R |
| refCommon_beam_index | RefCommonBeamIndex-rxx OPTIONAL -- Need R |

]]
RefCommonBeamIndex-rxx ::= SEQUENCE {

| | |
|---|---|
| servingcell-rxx | ServCellIndex-rxx |
| bwp-rxx | BWP-Id-rxx |

}
-- TAG-PUSCH-CONFIG-STOP
-- ASN1STOP

When the UE is configured with commonBeam1ANDcommonBeam2, it must be decided which PUSCH transmissions and/or which parts of a PUSCH transmission should be associated with which common beam index, for different PUSCH transmission schemes (e.g., TDM repetition, FDM repetition, SFN, spatial multiplexing, simultaneous transmission etc.).

In one embodiment, in case PUSCH is scheduled for time division multiplexing (TDM) repetition (i.e., where the same payload is transmitted in two different PUSCH transmission occasions transmitted at two different time instances), the first PUSCH repetition (i.e., first PUSCH transmission occasion) is associated with a first common beam index (i.e., a first indicated Joint DL/UL TCI state), and the second PUSCH repetition (i.e., second PUSCH transmission occasion) is associated with a second common beam index (i.e., a second indicated Joint DL/UL TCI state). In one embodiment, a codepoint in DCI scheduling the PUSCH can be used to change the ordering of the association between common beam index and the PUSCH transmission occasion. For example, in case the codepoint is ‘0’, the UE should associate a first common beam index with the first PUSCH repetition and a second common beam index with the second PUSCH repetition. By contrast, in case the codepoint is ‘1’, the UE should associate a second common beam index with the first PUSCH repetition and a first common beam index with the second PUSCH repetition. Note that the codepoints could be included in another bitfield in the DCI used to indicate for example other things, like which PUSCH transmission mode that is triggered, etc.

In one embodiment, in case PUSCH is scheduled for frequency division multiplexing (FDM) repetition (i.e., where the same payload is transmitted in two different PUSCH transmissions transmitted at two different frequency allocations within the same time symbols), the first PUSCH repetition (i.e., first PUSCH transmission occasion) scheduled over a first frequency allocation is associated with a first common beam index (i.e., a first indicated Joint DL/UL TCI state), and the second PUSCH repetition (i.e., second PUSCH transmission occasion) scheduled over a second frequency allocation is associated with a second common beam index (i.e., a second indicated Joint DL/UL TCI state). In one embodiment, a codepoint in DCI scheduling the PUSCH can be used to change the order of the association between common beam index and the PUSCH transmission occasion. For example, in case the codepoint is ‘0’, the UE should associate a first common beam index with the first PUSCH repetition scheduled over a first frequency allocation and a second common beam index with the second PUSCH repetition scheduled over a second frequency allocation. By contrast, in case the codepoint is ‘1’, the UE should associate a second common beam index with the first PUSCH repetition scheduled over a first frequency allocation and a first common beam index with the second PUSCH repetition scheduled over a second frequency allocation. In one embodiment, the first frequency allocation is scheduled using a first set of bits in the DCI scheduling the PUSCH, and the second frequency allocation is scheduled using a second set of bits in the DCI scheduling the PUSCH (where the first set of bits and second set of bits are different bits).

In one embodiment, in case PUSCH is scheduled for spatial multiplexing (i.e., where different sets of PUSCH layers are transmitted in two different PUSCH transmissions transmitted in overlapping time/frequency resources), the first PUSCH transmission associated with a first set of layers is associated with a first common beam index (i.e., a first indicated Joint DL/UL TCI state), and the second PUSCH transmission associated with a second set of PUSCH layers is associated with a second common beam index (i.e., a second indicated Joint DL/UL TCI state). In one embodiment, the first set of layers is indicated with a first transmission precoder matrix indicator (TPMI)/SRI field in the DCI scheduling the PUSCH transmission and the second set of layers is indicated with a second TPMI/SRI field in the DCI scheduling the PUSCH transmission. In one embodiment, the first set of layers is associated with a first CDM group indicated with the Antenna port bitfield (as specified in 3GPP TS 38.212 v17.0.0) included in the in the DCI scheduling the PUSCH transmission and the second set of layers is associated with a second CDM group indicated with the Antenna port bitfield included in the in the DCI scheduling the PUSCH transmission. So for example, in case the Antenna port bitfield in DCI scheduling the PUSCH indicates antenna (DMRS) port 0 belonging to CDM group 0 and antenna (DMRS) port 2 belonging to CDM group 1, then the UE should associate the PUSCH layer transmitted on antenna port 0 with a first common beam index (i.e. a first indicated Joint DL/UL TCI state), and associate the PUSCH layer transmitted on antenna port 2 with a second common beam index (i.e. a second indicated Joint DL/UL TCI state).

In one embodiment, a flag parameter may be configured as part of PUSCH-Config along with multi-TRP PUSCH configuration parameters. This flag parameter enables the use of the unified Joint DL/UL TCI state to be used for multi-TRP PUSCH schemes. If the flag parameter is not configured, then the UE may assume the rel-15/16 based spatial relation framework for mTRP PUSCH transmission. For instance, if the flag parameter is configured, then the UE is instructed to assume unified Joint DL/UL TCI state for deriving spatial filters for multi-TRP PUSCH schemes. If the flag is not configured, the UE is instructed to use spatial relations as indicated by the SRI fields in DCI that schedules the PUSCH transmission to derive the spatial filter for multi-TRP PUSCH schemes.

### Embodiments where Common Beam Indexes are Configured Per SRS Resource Set with Usage ‘Codebook’ or ‘nonCodebook’

In the following embodiments, it is assumed that a common beam index is explicitly configured per sounding reference signal (SRS) resource set (where SRS resource set is specified in TS 38.331 v16.7.0) with usage ‘codebook’ or ‘nonCodebook’, as schematically illustrated below:

| SRS-ResourceSet ::= | SEQUENCE { |
|---|---|
| [[ | |
| Common_beam_index | ENUMERATED {commonBeam1, |
| | commonBeam2} |

]]
}

SRS-ResourceSet is accordingly an example of configuration(s) 24 herein in FIG. 1, e.g., when the one or more uplink channels or signals 20 includes one or more SRS signals in one or more respective SRS resource sets.

In one embodiment, the UE is configured with two SRS resource sets with usage ‘codebook’ or ‘nonCodebook’, where each of the two sets are explicitly configured with one common beam index. In one embodiment, when the UE is triggered for transmission of the two SRS resource sets with usage ‘codebook’ or ‘nonCodebook’ and has two indicated Joint DL/UL TCI states, the UE should associate the transmission of the first SRS resource set with the common beam index explicitly configured in that SRS resource set. When the UE is scheduled with PUSCH transmission and is indicated with two Joint DL/UL TCI states, a first PUSCH transmission that is associated with a first SRS resource set should be transmitted using the common beam index explicitly configured in the first SRS resource set, and a second PUSCH transmission that is associated with a second SRS resource set should be transmitted using the common beam index explicitly configured in the second SRS resource set. The association between an SRS resource set and a PUSCH transmission could for example be based on two SRI/TPMI fields included in the DCI scheduling the PUSCH, where a first SRI/TPMI field is associate with a first SRS resource set and a first PUSCH transmission, and a second SRI/TPMI field is associate with a second SRS resource set and a second PUSCH transmission.

In one embodiment, in case the UE is configured with two SRS resource sets with usage ‘codebook’ or ‘nonCodebook’, and where each SRS resource set is explicitly configured with a common beam index, in case the UE is indicated with a single Joint DL/UL TCI state, the UE should de-activate one of the SRS resource sets (i.e., even if the UE is triggered with SRS transmission of the both SRS resource set, the UE should only transmit one of them).

In another embodiment, a flag to enable using unified Joint DL/UL state for SRS ResourceSet's with usage set to ‘codebook’ based or ‘non codebook’ based PUSCH is configured inside the SRS ResourceSet as shown below:

| | |
|---|---|
| SRS-ResourceSet ::= | SEQUENCE { |

[[

| | |
|---|---|
| followUnifiedTCIstate | ENUMERATED {enabled} OPTIONAL -- Need R |
| Common_beam_index | ENUMERATED {commonBeam1, commonBeam2} |
| | OPTIONAL -- Need R |

]]
}

This flag (denoted as ‘followUnifiedTCIstate’) indicates to the UE that when PUSCH is scheduled by indicating one or more SRS resources from this SRS resource set, then the transmit spatial filters to be used for PUSCH transmission is derived from the indicated/activated Joint DL/UL TCI state.

However, for the multi-TRP scenario, there will be multiple (e.g., 2) Joint DL/UL TCI states that are indicated/activated to the UE. In this case, multiple (e.g., 2) SRS resource sets are configured to the UE wherein each SRS resource set represents a transmission towards a TRP. To associate the SRS resource set with one of the Joint DL/UL TCI states, a ‘common_beam_index’ is configured per SRS resource set. In one embodiment, when the UE is triggered for transmission of the two SRS resource sets with usage ‘codebook’ or ‘nonCodebook’ and has two activated/indicated Joint DL/UL TCI states, the UE should associate the transmission of the first SRS resource set with the common beam index explicitly configured in that SRS resource set. Similarly, the UE should associate the transmission of the second SRS resource set with the common beam index explicitly configured in that SRS resource set. In this embodiment, the first SRS resource set and the second SRS resource set may be associated with different common beam indices.

### Embodiments where Common Beam Indexes are Configured Per SRS Resource in One SRS Resource Set with Usage ‘Codebook’ or ‘nonCodebook’

In the following embodiments it is assumed that a common beam index is explicitly configured per SRS resource (as specified in TS 38.331 v16.7.0) in an SRS resource set with usage ‘codebook’ or ‘nonCodebook’, as schematically illustrated below:

| | |
|---|---|
| SRS-Resource ::= | SEQUENCE { |

[[

| | |
|---|---|
| Common_beam_index | ENUMERATED {commonBeam1, |
| | commonBeam2} |

]]
}

SRS-Resource is accordingly an example of configuration(s) 24 herein in FIG. 1, e.g., when the one or more uplink channels or signals 20 includes one or more SRS signals in one or more respective SRS resources.

In one embodiment, the UE is configured with one SRS resource set with usage ‘codebook’, where the SRS resource set consists of two SRS resources, and where each SRS resource is explicitly configured with one common beam index. In one embodiment, when the UE is triggered for transmission of the SRS resource set with usage ‘codebook and has two indicated Joint DL/UL TCI states, the UE should associate the transmission of the first SRS resource with the common beam index explicitly configured in the first SRS resource and the second SRS resource with the common beam index explicitly configured in the second SRS resource. When the UE is scheduled with PUSCH transmission and is indicated with two Joint DL/UL TCI states, a first PUSCH transmission that is associated with a first SRS resource, should be transmitted using the common beam index explicitly configured in the first SRS resource, and a second PUSCH transmission that is associated with a second SRS resource, should be transmitted using the common beam index explicitly configured in the second SRS resource. The association between an SRS resource and a PUSCH transmission could for example be based on one or more SRI and/or TPMI fields included in the DCI scheduling the PUSCH, where for example a first SRI and/or TPMI field (or codepoint(s) of a SRI/TPMI field) is associated with a first SRS resource and a first PUSCH transmission, and a second SRI and/or TPMI field (or codepoint(s) of a SRI/TPMI fields) is associated with a second SRS resource and a second PUSCH transmission.

The same embodiment can be applied for an SRS resource set with usage ‘nonCodebook’, where each of the SRS resources in the SRS resource set with usage ‘nonCodebook’ is configured with one out of two explicit common beam indexes.

In one embodiment, in case the UE is configured with two SRS resources in a SRS resource set with usage ‘codebook’, and where each SRS resource is explicitly configured with a common beam index, in case the UE is indicated with a single Joint DL/UL TCI state, the UE should de-activate one of the SRS resources (i.e. even if the UE is triggered with SRS transmission of the both SRS resources, the UE should only transmit one of them).

In another embodiment, a flag to enable using unified Joint DL/UL state for SRS Resource's configured in an SRS resource set with usage set to ‘codebook’ based or ‘non codebook’ based PUSCH is configured inside the SRS Resource as shown below:

| | |
|---|---|
| SRS-Resource ::= | SEQUENCE { |

[[

| | |
|---|---|
| followUnifiedTCIstate | ENUMERATED {enabled} OPTIONAL -- Need R |
| Common_beam_index | ENUMERATED {commonBeam1, commonBeam2} |
| | OPTIONAL -- Need R |

]]
}

This flag (denoted as ‘followUnifiedTCIstate’) indicates to the UE that when PUSCH is scheduled by indicating a specific SRS resource from an SRS resource set with usage set to ‘codebook’ based or ‘non codebook’ based PUSCH, then the transmit spatial filters to be used for PUSCH transmission associated with the indicated SRS resource is derived from the indicated/activated Joint DL/UL TCI state.

However, for the multi-TRP scenario, there will be multiple (e.g., 2) Joint DL/UL TCI states that are indicated/activated to the UE. In this case, multiple (e.g., 2) SRS resources belonging to the same SRS resource set are configured to the UE wherein each SRS resource represents a transmission towards a TRP. To associate the SRS resource with one of the Joint DL/UL TCI states, a ‘common_beam_index’ is configured per SRS resource. In one embodiment, when the UE is triggered for transmission of the two SRS resources belonging to a SRS resource set with usage ‘codebook’ or ‘nonCodebook’ and has two activated/indicated Joint DL/UL TCI states, the UE should associate the transmission of the first SRS resource with the common beam index explicitly configured in that SRS resource. Similarly, the UE should associate the transmission of the second SRS resource with the common beam index explicitly configured in that SRS resource. In this embodiment, the first SRS resource and the second SRS resource may be associated with different common beam indices.

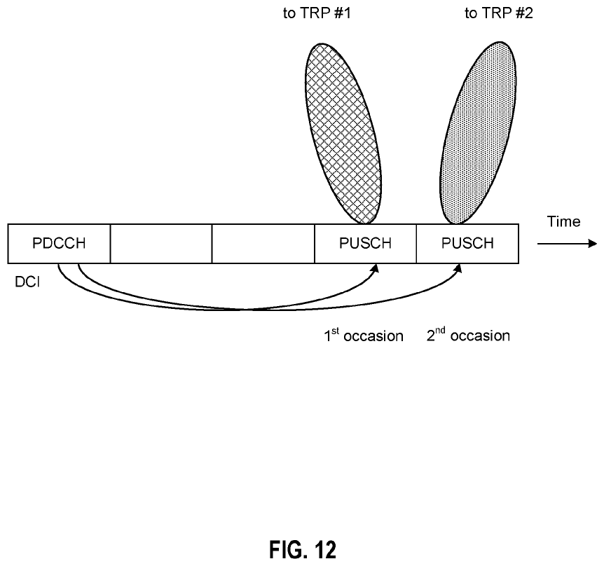

In view of the modifications and variations herein, FIG. 14 depicts a method performed by a communication device configured for use in a communication network. The method comprises receiving, for each of one or more uplink channels or signals, a configuration that indicates with which of multiple activated unified transmission configuration indication, TCI, states the uplink channel or signal is associated (Block 1400).

In some embodiments, the configuration for each uplink channel or signal includes a TCI state pointer that points to one or more of the multiple activated unified TCI states with which the uplink channel or signal is associated. In one or more of these embodiments, the TCI state pointer is a common beam index. In one or more of these embodiments, activation signaling that activates the multiple unified TCI states associates the multiple unified TCI states with respective indices or identifiers. In some embodiments, the TCI state pointer included in the configuration for each uplink channel or signal points to one or more activated unified TCI states by pointing to the one or more indices or identifiers associated with the one or more activated unified TCI states. In one or more of these embodiments, the multiple activated unified TCI states includes first and second activated unified TCI states. In some embodiments, the activation signaling associates the first and second activated unified TCI states with first and second identifiers, respectively. In some embodiments, the TCI state pointer included in the configuration for at least one uplink channel or signal points to the first activated unified TCI state and/or the second activated unified TCI state by pointing to the first identifier, the second identifier, or both the first identifier and the second identifier. In one or more of these embodiments, the multiple activated unified TCI states includes first and second activated unified TCI states. In some embodiments, the activation signaling associates the first and second activated unified TCI states with first and second identifiers, respectively. In some embodiments, a field in downlink control signaling indicates whether the TCI state pointer included in the configuration for at least one uplink channel or signal points to the first activated unified TCI state and/or the second activated unified TCI state by pointing to the first identifier, the second identifier, or both the first identifier and the second identifier. Alternatively, a field in downlink control signaling indicates whether the TCI state pointer included in the configuration for at least one uplink channel or signal points to the first activated unified TCI state and/or the second activated unified TCI state by pointing to the second identifier, the first identifier, or both the second identifier and the first identifier. In one or more of these embodiments, the activation signaling includes a first field that activates the first activated unified TCI state and a second field that activates the second activated unified TCI state. In some embodiments, the first field occurs before the second field in the activation signaling. In one or more of these embodiments, the method further comprises receiving the activation signaling (Block 1410). In one or more of these embodiments, the activation signaling is received after receipt of the configuration for at least one of the one or more uplink channels or signals.

In some embodiments, the configuration for each uplink channel or signal explicitly indicates with which of the multiple activated unified TCI states the uplink channel or signal is associated.

In some embodiments, the multiple activated unified TCI states are associated with multiple respective transmission reception points, TRPs.

In some embodiments, said receiving comprises receiving, for each of one or more uplink channels, a configuration that indicates with which of multiple activated unified TCI states the uplink channel is associated. In one or more of these embodiments, the one or more uplink channels include an uplink data channel. In one or more of these embodiments, the uplink data channel is a Physical Uplink Shared Channel, PUSCH. In one or more of these embodiments, the configuration received for the PUSCH is a PUSCH configuration or a PUSCH serving cell configuration.

In some embodiments, the configuration for at least one uplink channel or signal includes a field that indicates whether a unified TCI framework or a spatial relation framework applies.

In some embodiments, said receiving comprises receiving, for each of one or more uplink signals, a configuration that indicates with which of multiple activated unified TCI states the uplink signal is associated. In one or more of these embodiments, the one or more uplink signals are one or more sounding reference signal, SRS, signals. In one or more of these embodiments, the one or more SRS signals are one or more SRS signals in one or more SRS resource sets. In one or more of these embodiments, the configuration for an SRS signal in an SRS resource set indicates with which of the multiple activated unified TCI states the SRS signal in that SRS resource set is associated by indicating with which of the multiple activated unified TCI states the SRS resource set is associated. In one or more of these embodiments, the configuration received for each of the one or more SRS signals in the one or more SRS resource sets is an SRS resource set configuration. In one or more of these embodiments, the one or more SRS signals are one or more SRS signals in one or more SRS resources of the same SRS resource set. In one or more of these embodiments, the configuration for an SRS signal in an SRS resource of the SRS resource set indicates with which of the multiple activated unified TCI states the SRS signal in that SRS resource is associated by indicating with which of the multiple activated unified TCI states the SRS resource is associated. In one or more of these embodiments, the configuration received for each of the one or more SRS signals in the one or more SRS resources of the SRS resource set is an SRS resource configuration.

In some embodiments, each activated unified TCI state contains quasi co-location, QCL, information between antenna ports of the communication device.

In some embodiments, each activated unified TCI state is applicable for multiple channels or signals.

In some embodiments, the multiple activated unified TCI states are joint uplink/downlink TCI states. In some embodiments, each joint TCI state is applicable for both downlink transmissions and uplink transmissions.

In some embodiments, the multiple activated unified TCI states are uplink TCI states. In some embodiments, each uplink TCI state is applicable only for uplink transmissions.

In some embodiments, the method further comprises determining, for each of the one or more uplink channels or signals, a spatial filter for the uplink channel or signal based on one or more activated unified TCI states that are associated with the uplink channel or signal according to the configuration received for that uplink channel or signal (Block 1420). In one or more of these embodiments, the method further comprises transmitting the one or more uplink channels or signals using the one or more spatial filters determined for the one or more uplink channels or signals (Block 1430).

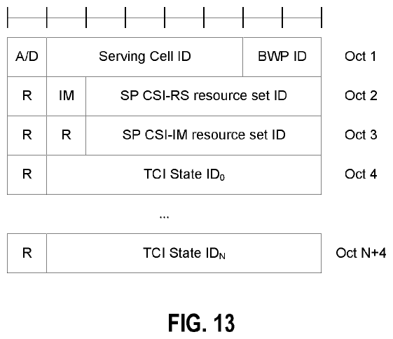

FIG. 15 shows a method performed by a network node configured for use in a communication network. The method comprises transmitting, to a communication device, for each of one or more uplink channels or signals, a configuration that indicates with which of multiple activated unified transmission configuration indication, TCI, states the uplink channel or signal is associated (Block 1500).

In some embodiments, the configuration for each uplink channel or signal includes a TCI state pointer that points to one or more of the multiple activated unified TCI states with which the uplink channel or signal is associated. In one or more of these embodiments, the TCI state pointer is a common beam index. In one or more of these embodiments, activation signaling that activates the multiple unified TCI states associates the multiple unified TCI states with respective indices or identifiers. In some embodiments, the TCI state pointer included in the configuration for each uplink channel or signal points to one or more activated unified TCI states by pointing to the one or more indices or identifiers associated with the one or more activated unified TCI states. In one or more of these embodiments, the multiple activated unified TCI states includes first and second activated unified TCI states. In some embodiments, the activation signaling associates the first and second activated unified TCI states with first and second identifiers, respectively. In some embodiments, the TCI state pointer included in the configuration for at least one uplink channel or signal points to the first activated unified TCI state and/or the second activated unified TCI state by pointing to the first identifier, the second identifier, or both the first identifier and the second identifier. In one or more of these embodiments, the multiple activated unified TCI states includes first and second activated unified TCI states. In some embodiments, the activation signaling associates the first and second activated unified TCI states with first and second identifiers, respectively. In some embodiments, a field in downlink control signaling indicates whether the TCI state pointer included in the configuration for at least one uplink channel or signal points to the first activated unified TCI state and/or the second activated unified TCI state by pointing to the first identifier, the second identifier, or both the first identifier and the second identifier. Alternatively, a field in downlink control signaling indicates whether the TCI state pointer included in the configuration for at least one uplink channel or signal points to the first activated unified TCI state and/or the second activated unified TCI state by pointing to the second identifier, the first identifier, or both the second identifier and the first identifier. In one or more of these embodiments, the activation signaling includes a first field that activates the first activated unified TCI state and a second field that activates the second activated unified TCI state. In some embodiments, the first field occurs before the second field in the activation signaling. In one or more of these embodiments, the method further comprises transmitting the activation signaling (Block 1510). In one or more of these embodiments, the activation signaling is transmitted after transmission of the configuration for at least one of the one or more uplink channels or signals.

In some embodiments, the configuration for each uplink channel or signal explicitly indicates with which of the multiple activated unified TCI states the uplink channel or signal is associated.

In some embodiments, the multiple activated unified TCI states are associated with multiple respective transmission reception points, TRPs.

In some embodiments, said transmitting comprises transmitting, for each of one or more uplink channels, a configuration that indicates with which of multiple activated unified TCI states the uplink channel is associated. In one or more of these embodiments, the one or more uplink channels include an uplink data channel. In one or more of these embodiments, the uplink data channel is a Physical Uplink Shared Channel, PUSCH. In one or more of these embodiments, the configuration transmitted for the PUSCH is a PUSCH configuration or a PUSCH serving cell configuration.

In some embodiments, the configuration for at least one uplink channel or signal includes a field that indicates whether a unified TCI framework or a spatial relation framework applies.

In some embodiments, said transmitting comprises transmitting, for each of one or more uplink signals, a configuration that indicates with which of multiple activated unified TCI states the uplink signal is associated. In one or more of these embodiments, the one or more uplink signals are one or more sounding reference signal, SRS, signals. In one or more of these embodiments, the one or more SRS signals are one or more SRS signals in one or more SRS resource sets. In one or more of these embodiments, the configuration for an SRS signal in an SRS resource set indicates with which of the multiple activated unified TCI states the SRS signal in that SRS resource set is associated by indicating with which of the multiple activated unified TCI states the SRS resource set is associated. In one or more of these embodiments, the configuration transmitted for each of the one or more SRS signals in the one or more SRS resource sets is an SRS resource set configuration. In one or more of these embodiments, the one or more SRS signals are one or more SRS signals in one or more SRS resources of the same SRS resource set. In one or more of these embodiments, the configuration for an SRS signal in an SRS resource of the SRS resource set indicates with which of the multiple activated unified TCI states the SRS signal in that SRS resource is associated by indicating with which of the multiple activated unified TCI states the SRS resource is associated. In one or more of these embodiments, the configuration transmitted for each of the one or more SRS signals in the one or more SRS resources of the SRS resource set is an SRS resource configuration.

In some embodiments, each activated unified TCI state contains quasi co-location, QCL, information between antenna ports of the communication device.

In some embodiments, each activated unified TCI state is applicable for multiple channels or signals.

In some embodiments, the multiple activated unified TCI states are joint uplink/downlink TCI states. In some embodiments, each joint TCI state is applicable for both downlink transmissions and uplink transmissions.

In some embodiments, the multiple activated unified TCI states are uplink TCI states. In some embodiments, each uplink TCI state is applicable only for uplink transmissions.

Embodiments herein also include corresponding apparatuses. Embodiments herein for instance include a communication device 12 configured to perform any of the steps of any of the embodiments described above for the communication device 12.

Embodiments also include a communication device 12 comprising processing circuitry and power supply circuitry. The processing circuitry is configured to perform any of the steps of any of the embodiments described above for the communication device 12. The power supply circuitry is configured to supply power to the communication device 12.

Embodiments further include a communication device 12 comprising processing circuitry. The processing circuitry is configured to perform any of the steps of any of the embodiments described above for the communication device 12. In some embodiments, the communication device 12 further comprises communication circuitry.

Embodiments further include a communication device 12 comprising processing circuitry and memory. The memory contains instructions executable by the processing circuitry whereby the communication device 12 is configured to perform any of the steps of any of the embodiments described above for the communication device 12.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the communication device 12. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a network node 14 configured to perform any of the steps of any of the embodiments described above for the network node 14.

Embodiments also include a network node 14 comprising processing circuitry and power supply circuitry. The processing circuitry is configured to perform any of the steps of any of the embodiments described above for the network node 14. The power supply circuitry is configured to supply power to the network node 14.

Embodiments further include a network node 14 comprising processing circuitry. The processing circuitry is configured to perform any of the steps of any of the embodiments described above for the network node 14. In some embodiments, the network node 14 further comprises communication circuitry.

Embodiments further include a network node 14 comprising processing circuitry and memory. The memory contains instructions executable by the processing circuitry whereby the network node 14 is configured to perform any of the steps of any of the embodiments described above for the network node 14.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

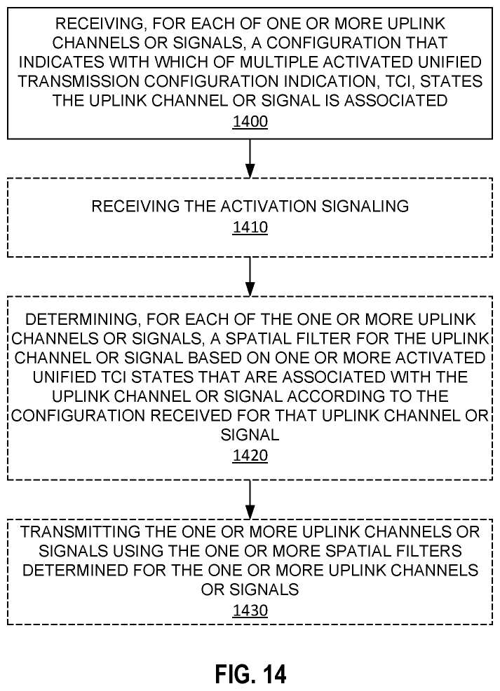

FIG. 16 for example illustrates a communication device 12 as implemented in accordance with one or more embodiments. As shown, the communication device 12 includes processing circuitry 1610 and communication circuitry 1620. The communication circuitry 1620 (e.g., radio circuitry) is configured to transmit and/or receive information to and/or from one or more other nodes, e.g., via any communication technology. Such communication may occur via one or more antennas that are either internal or external to the wireless communication device 1600. The processing circuitry 1610 is configured to perform processing described above, e.g., in FIG. 14, such as by executing instructions stored in memory 1630. The processing circuitry 1610 in this regard may implement certain functional means, units, or modules.

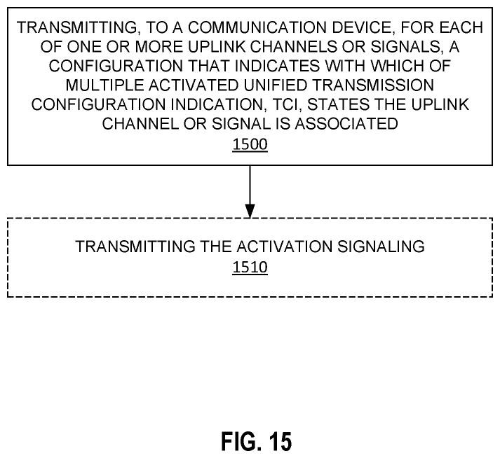

FIG. 17 illustrates a network node 14 as implemented in accordance with one or more embodiments. As shown, the network node 14 includes processing circuitry 1710 and communication circuitry 1720. The communication circuitry 1720 is configured to transmit and/or receive information to and/or from one or more other nodes, e.g., via any communication technology. The processing circuitry 1710 is configured to perform processing described above, e.g., in FIG. 15, such as by executing instructions stored in memory 1730. The processing circuitry 1710 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

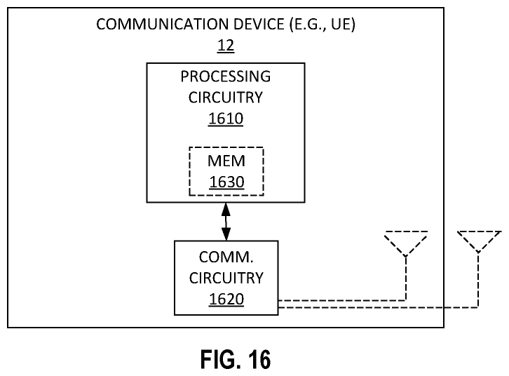

FIG. 18 shows an example of a communication system 1800 in accordance with some embodiments.

In the example, the communication system 1800 includes a telecommunication network 1802 that includes an access network 1804, such as a radio access network (RAN), and a core network 1806, which includes one or more core network nodes 1808. The access network 1804 includes one or more access network nodes, such as network nodes 1810a and 1810b (one or more of which may be generally referred to as network nodes 1810), or any other similar 3^{rd} Generation Partnership Project (3GPP) access node or non-3GPP access point. The network nodes 1810 facilitate direct or indirect connection of user equipment (UE), such as by connecting UEs 1812a, 1812b, 1812c, and 1812d (one or more of which may be generally referred to as UEs 1812) to the core network 1806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1800 may include any number of wired or wireless networks, network nodes, UEs, and/or any other components or systems that may facilitate or participate in the communication of data and/or signals whether via wired or wireless connections. The communication system 1800 may include and/or interface with any type of communication, telecommunication, data, cellular, radio network, and/or other similar type of system.

The UEs 1812 may be any of a wide variety of communication devices, including wireless devices arranged, configured, and/or operable to communicate wirelessly with the network nodes 1810 and other communication devices. Similarly, the network nodes 1810 are arranged, capable, configured, and/or operable to communicate directly or indirectly with the UEs 1812 and/or with other network nodes or equipment in the telecommunication network 1802 to enable and/or provide network access, such as wireless network access, and/or to perform other functions, such as administration in the telecommunication network 1802.

In the depicted example, the core network 1806 connects the network nodes 1810 to one or more hosts, such as host 1816. These connections may be direct or indirect via one or more intermediary networks or devices. In other examples, network nodes may be directly coupled to hosts. The core network 1806 includes one more core network nodes (e.g., core network node 1808) that are structured with hardware and software components. Features of these components may be substantially similar to those described with respect to the UEs, network nodes, and/or hosts, such that the descriptions thereof are generally applicable to the corresponding components of the core network node 1808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1816 may be under the ownership or control of a service provider other than an operator or provider of the access network 1804 and/or the telecommunication network 1802, and may be operated by the service provider or on behalf of the service provider. The host 1816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1800 of FIG. 18 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1802 is a cellular network that implements 3GPP standardized features. Accordingly, the telecommunications network 1802 may support network slicing to provide different logical networks to different devices that are connected to the telecommunication network 1802. For example, the telecommunications network 1802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1812 are configured to transmit and/or receive information without direct human interaction. For instance, a UE may be designed to transmit information to the access network 1804 on a predetermined schedule, when triggered by an internal or external event, or in response to requests from the access network 1804. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1814 communicates with the access network 1804 to facilitate indirect communication between one or more UEs (e.g., UE 1812c and/or 1812d) and network nodes (e.g., network node 1810b). In some examples, the hub 1814 may be a controller, router, content source and analytics, or any of the other communication devices described herein regarding UEs. For example, the hub 1814 may be a broadband router enabling access to the core network 1806 for the UEs. As another example, the hub 1814 may be a controller that sends commands or instructions to one or more actuators in the UEs. Commands or instructions may be received from the UEs, network nodes 1810, or by executable code, script, process, or other instructions in the hub 1814. As another example, the hub 1814 may be a data collector that acts as temporary storage for UE data and, in some embodiments, may perform analysis or other processing of the data. As another example, the hub 1814 may be a content source. For example, for a UE that is a VR headset, display, loudspeaker or other media delivery device, the hub 1814 may retrieve VR assets, video, audio, or other media or data related to sensory information via a network node, which the hub 1814 then provides to the UE either directly, after performing local processing, and/or after adding additional local content. In still another example, the hub 1814 acts as a proxy server or orchestrator for the UEs, in particular in if one or more of the UEs are low energy IoT devices.

The hub 1814 may have a constant/persistent or intermittent connection to the network node 1810b. The hub 1814 may also allow for a different communication scheme and/or schedule between the hub 1814 and UEs (e.g., UE 1812c and/or 1812d), and between the hub 1814 and the core network 1806. In other examples, the hub 1814 is connected to the core network 1806 and/or one or more UEs via a wired connection. Moreover, the hub 1814 may be configured to connect to an M2M service provider over the access network 1804 and/or to another UE over a direct connection. In some scenarios, UEs may establish a wireless connection with the network nodes 1810 while still connected via the hub 1814 via a wired or wireless connection. In some embodiments, the hub 1814 may be a dedicated hub—that is, a hub whose primary function is to route communications to/from the UEs from/to the network node 1810b. In other embodiments, the hub 1814 may be a non-dedicated hub—that is, a device which is capable of operating to route communications between the UEs and network node 1810b, but which is additionally capable of operating as a communication start and/or end point for certain data channels.

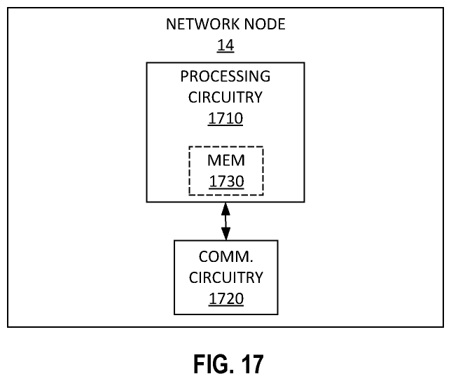

FIG. 19 shows a UE 1900 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3^{rd} Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1900 includes processing circuitry 1902 that is operatively coupled via a bus 1904 to an input/output interface 1906, a power source 1908, a memory 1910, a communication interface 1912, and/or any other component, or any combination thereof. Certain UEs may utilize all or a subset of the components shown in FIG. 19. The level of integration between the components may vary from one UE to another UE. Further, certain UEs may contain multiple instances of a component, such as multiple processors, memories, transceivers, transmitters, receivers, etc.

The processing circuitry 1902 is configured to process instructions and data and may be configured to implement any sequential state machine operative to execute instructions stored as machine-readable computer programs in the memory 1910. The processing circuitry 1902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1902 may include multiple central processing units (CPUs).

In the example, the input/output interface 1906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1908 is structured as a battery or battery pack. Other types of power sources, such as an external power source (e.g., an electricity outlet), photovoltaic device, or power cell, may be used. The power source 1908 may further include power circuitry for delivering power from the power source 1908 itself, and/or an external power source, to the various parts of the UE 1900 via input circuitry or an interface such as an electrical power cable. Delivering power may be, for example, for charging of the power source 1908. Power circuitry may perform any formatting, converting, or other modification to the power from the power source 1908 to make the power suitable for the respective components of the UE 1900 to which power is supplied.

The memory 1910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1910 includes one or more application programs 1914, such as an operating system, web browser application, a widget, gadget engine, or other application, and corresponding data 1916. The memory 1910 may store, for use by the UE 1900, any of a variety of various operating systems or combinations of operating systems.

The memory 1910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1910 may allow the UE 1900 to access instructions, application programs and the like, stored on transitory or non-transitory memory media, to off-load data, or to upload data. An article of manufacture, such as one utilizing a communication system may be tangibly embodied as or in the memory 1910, which may be or comprise a device-readable storage medium.

The processing circuitry 1902 may be configured to communicate with an access network or other network using the communication interface 1912. The communication interface 1912 may comprise one or more communication subsystems and may include or be communicatively coupled to an antenna 1922. The communication interface 1912 may include one or more transceivers used to communicate, such as by communicating with one or more remote transceivers of another device capable of wireless communication (e.g., another UE or a network node in an access network). Each transceiver may include a transmitter 1918 and/or a receiver 1920 appropriate to provide network communications (e.g., optical, electrical, frequency allocations, and so forth). Moreover, the transmitter 1918 and receiver 1920 may be coupled to one or more antennas (e.g., antenna 1922) and may share circuit components, software or firmware, or alternatively be implemented separately.

In the illustrated embodiment, communication functions of the communication interface 1912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1900 shown in FIG. 19.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

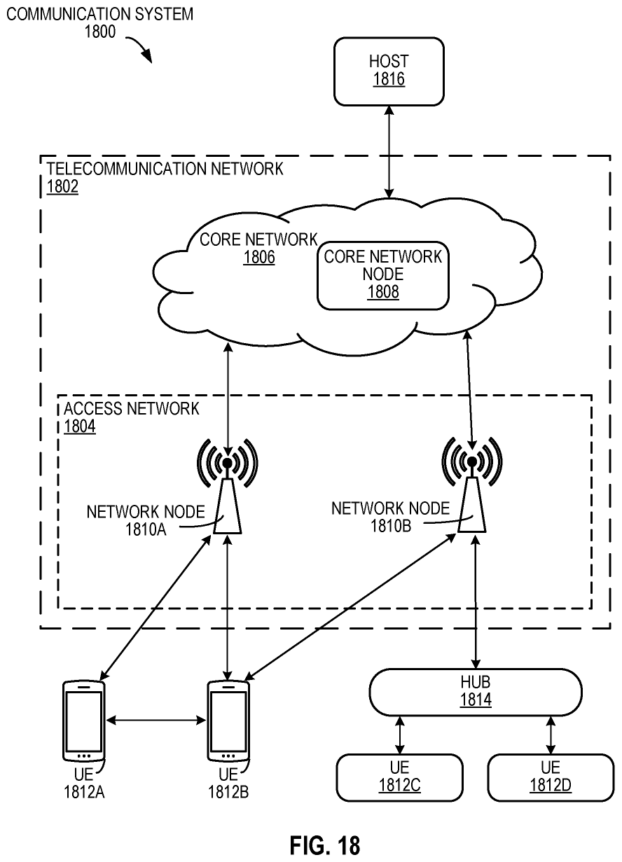

FIG. 20 shows a network node 2000 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 2000 includes a processing circuitry 2002, a memory 2004, a communication interface 2006, and a power source 2008. The network node 2000 may be composed of multiple physically separate components (e.g., a NodeB component and a RNC component, or a BTS component and a BSC component, etc.), which may each have their own respective components. In certain scenarios in which the network node 2000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 2000 may be configured to support multiple radio access technologies (RATs). In such embodiments, some components may be duplicated (e.g., separate memory 2004 for different RATs) and some components may be reused (e.g., a same antenna 2010 may be shared by different RATs). The network node 2000 may also include multiple sets of the various illustrated components for different wireless technologies integrated into network node 2000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 2000.

The processing circuitry 2002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2000 components, such as the memory 2004, to provide network node 2000 functionality.

In some embodiments, the processing circuitry 2002 includes a system on a chip (SOC). In some embodiments, the processing circuitry 2002 includes one or more of radio frequency (RF) transceiver circuitry 2012 and baseband processing circuitry 2014. In some embodiments, the radio frequency (RF) transceiver circuitry 2012 and the baseband processing circuitry 2014 may be on separate chips (or sets of chips), boards, or units, such as radio units and digital units. In alternative embodiments, part or all of RF transceiver circuitry 2012 and baseband processing circuitry 2014 may be on the same chip or set of chips, boards, or units.

The memory 2004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 2002. The memory 2004 may store any suitable instructions, data, or information, including a computer program, software, an application including one or more of logic, rules, code, tables, and/or other instructions capable of being executed by the processing circuitry 2002 and utilized by the network node 2000. The memory 2004 may be used to store any calculations made by the processing circuitry 2002 and/or any data received via the communication interface 2006. In some embodiments, the processing circuitry 2002 and memory 2004 is integrated.

The communication interface 2006 is used in wired or wireless communication of signaling and/or data between a network node, access network, and/or UE. As illustrated, the communication interface 2006 comprises port(s)/terminal(s) 2016 to send and receive data, for example to and from a network over a wired connection. The communication interface 2006 also includes radio front-end circuitry 2018 that may be coupled to, or in certain embodiments a part of, the antenna 2010. Radio front-end circuitry 2018 comprises filters 2020 and amplifiers 2022. The radio front-end circuitry 2018 may be connected to an antenna 2010 and processing circuitry 2002. The radio front-end circuitry may be configured to condition signals communicated between antenna 2010 and processing circuitry 2002. The radio front-end circuitry 2018 may receive digital data that is to be sent out to other network nodes or UEs via a wireless connection. The radio front-end circuitry 2018 may convert the digital data into a radio signal having the appropriate channel and bandwidth parameters using a combination of filters 2020 and/or amplifiers 2022. The radio signal may then be transmitted via the antenna 2010. Similarly, when receiving data, the antenna 2010 may collect radio signals which are then converted into digital data by the radio front-end circuitry 2018. The digital data may be passed to the processing circuitry 2002. In other embodiments, the communication interface may comprise different components and/or different combinations of components.

In certain alternative embodiments, the network node 2000 does not include separate radio front-end circuitry 2018, instead, the processing circuitry 2002 includes radio front-end circuitry and is connected to the antenna 2010. Similarly, in some embodiments, all or some of the RF transceiver circuitry 2012 is part of the communication interface 2006. In still other embodiments, the communication interface 2006 includes one or more ports or terminals 2016, the radio front-end circuitry 2018, and the RF transceiver circuitry 2012, as part of a radio unit (not shown), and the communication interface 2006 communicates with the baseband processing circuitry 2014, which is part of a digital unit (not shown).

The antenna 2010 may include one or more antennas, or antenna arrays, configured to send and/or receive wireless signals. The antenna 2010 may be coupled to the radio front-end circuitry 2018 and may be any type of antenna capable of transmitting and receiving data and/or signals wirelessly. In certain embodiments, the antenna 2010 is separate from the network node 2000 and connectable to the network node 2000 through an interface or port.

The antenna 2010, communication interface 2006, and/or the processing circuitry 2002 may be configured to perform any receiving operations and/or certain obtaining operations described herein as being performed by the network node. Any information, data and/or signals may be received from a UE, another network node and/or any other network equipment. Similarly, the antenna 2010, the communication interface 2006, and/or the processing circuitry 2002 may be configured to perform any transmitting operations described herein as being performed by the network node. Any information, data and/or signals may be transmitted to a UE, another network node and/or any other network equipment.

The power source 2008 provides power to the various components of network node 2000 in a form suitable for the respective components (e.g., at a voltage and current level needed for each respective component). The power source 2008 may further comprise, or be coupled to, power management circuitry to supply the components of the network node 2000 with power for performing the functionality described herein. For example, the network node 2000 may be connectable to an external power source (e.g., the power grid, an electricity outlet) via an input circuitry or interface such as an electrical cable, whereby the external power source supplies power to power circuitry of the power source 2008. As a further example, the power source 2008 may comprise a source of power in the form of a battery or battery pack which is connected to, or integrated in, power circuitry. The battery may provide backup power should the external power source fail.

Embodiments of the network node 2000 may include additional components beyond those shown in FIG. 20 for providing certain aspects of the network node's functionality, including any of the functionality described herein and/or any functionality necessary to support the subject matter described herein. For example, the network node 2000 may include user interface equipment to allow input of information into the network node 2000 and to allow output of information from the network node 2000. This may allow a user to perform diagnostic, maintenance, repair, and other administrative functions for the network node 2000.

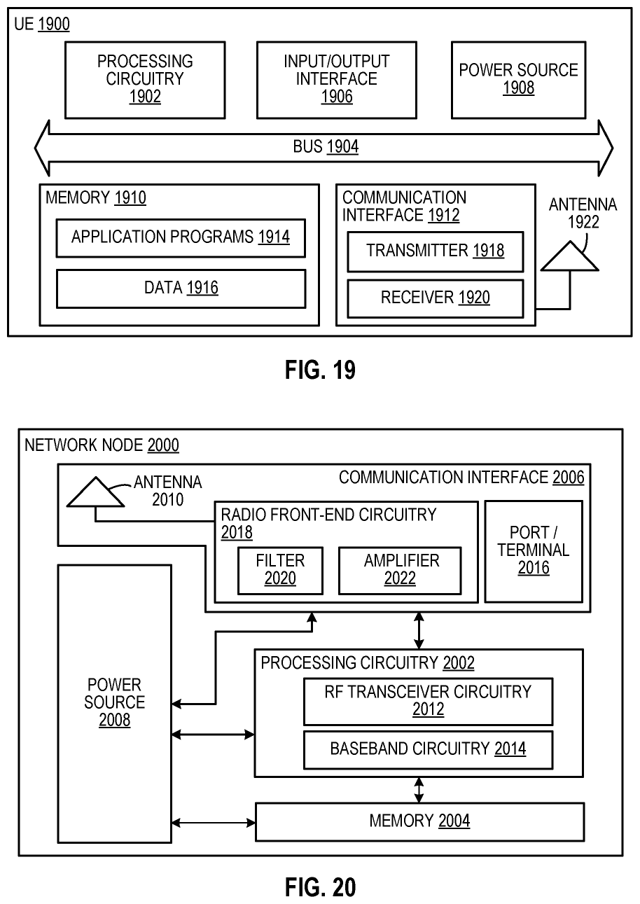

FIG. 21 is a block diagram of a host 2100, which may be an embodiment of the host 1816 of FIG. 18, in accordance with various aspects described herein. As used herein, the host 2100 may be or comprise various combinations hardware and/or software, including a standalone server, a blade server, a cloud-implemented server, a distributed server, a virtual machine, container, or processing resources in a server farm. The host 2100 may provide one or more services to one or more UEs.

The host 2100 includes processing circuitry 2102 that is operatively coupled via a bus 2104 to an input/output interface 2106, a network interface 2108, a power source 2110, and a memory 2112. Other components may be included in other embodiments. Features of these components may be substantially similar to those described with respect to the devices of previous figures, such as FIGS. 19 and 20, such that the descriptions thereof are generally applicable to the corresponding components of host 2100.

The memory 2112 may include one or more computer programs including one or more host application programs 2114 and data 2116, which may include user data, e.g., data generated by a UE for the host 2100 or data generated by the host 2100 for a UE. Embodiments of the host 2100 may utilize only a subset or all of the components shown. The host application programs 2114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 2114 may also provide for user authentication and licensing checks and may periodically report health, routes, and content availability to a central node, such as a device in or on the edge of a core network. Accordingly, the host 2100 may select and/or indicate a different host for over-the-top services for a UE. The host application programs 2114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

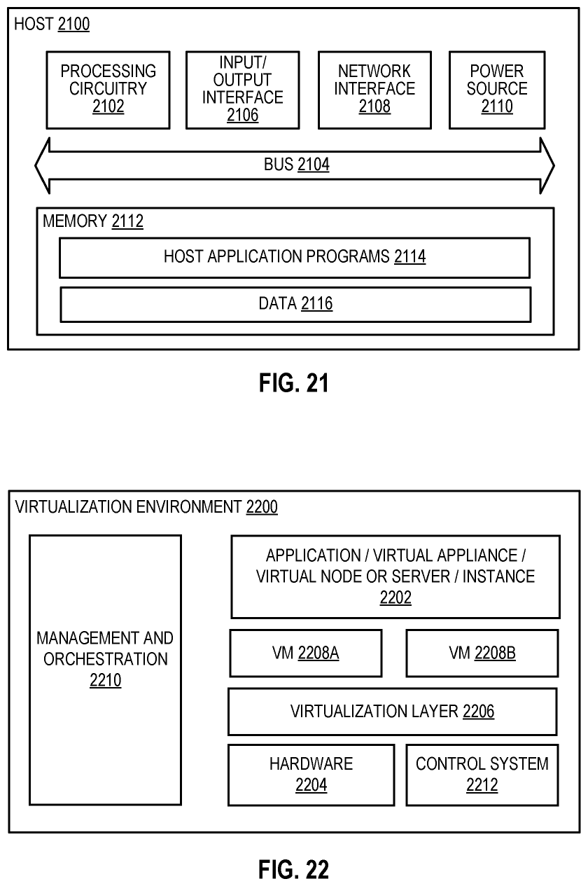

FIG. 22 is a block diagram illustrating a virtualization environment 2200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2202 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 2204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2206 (also referred to as hypervisors or virtual machine monitors (VMMs)), provide VMs 2208a and 2208b (one or more of which may be generally referred to as VMs 2208), and/or perform any of the functions, features and/or benefits described in relation with some embodiments described herein. The virtualization layer 2206 may present a virtual operating platform that appears like networking hardware to the VMs 2208.

The VMs 2208 comprise virtual processing, virtual memory, virtual networking or interface and virtual storage, and may be run by a corresponding virtualization layer 2206. Different embodiments of the instance of a virtual appliance 2202 may be implemented on one or more of VMs 2208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2208 may be a software implementation of a physical machine that runs programs as if they were executing on a physical, non-virtualized machine. Each of the VMs 2208, and that part of hardware 2204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2208 on top of the hardware 2204 and corresponds to the application 2202.

Hardware 2204 may be implemented in a standalone network node with generic or specific components. Hardware 2204 may implement some functions via virtualization. Alternatively, hardware 2204 may be part of a larger cluster of hardware (e.g. such as in a data center or CPE) where many hardware nodes work together and are managed via management and orchestration 2210, which, among others, oversees lifecycle management of applications 2202. In some embodiments, hardware 2204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2212 which may alternatively be used for communication between hardware nodes and radio units.

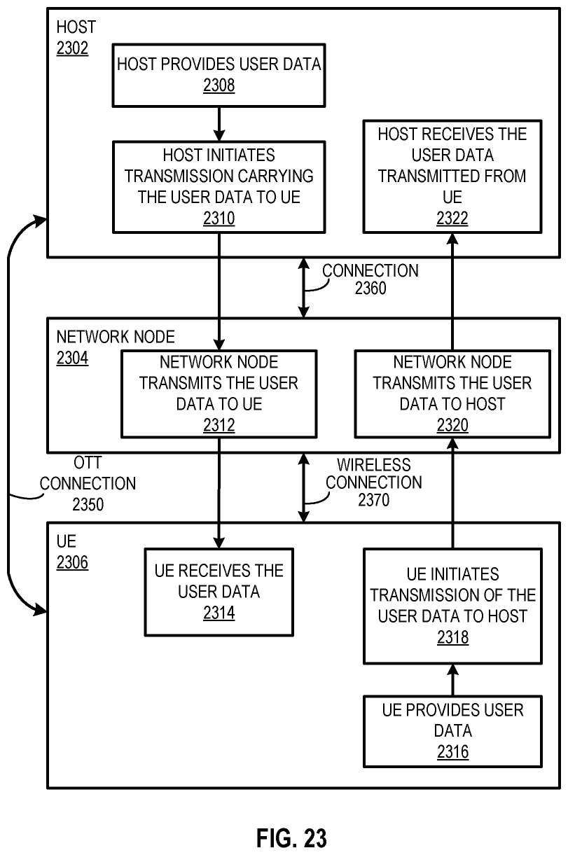

FIG. 23 shows a communication diagram of a host 2302 communicating via a network node 2304 with a UE 2306 over a partially wireless connection in accordance with some embodiments. Example implementations, in accordance with various embodiments, of the UE (such as a UE 1812a of FIG. 18 and/or UE 1900 of FIG. 19), network node (such as network node 1810a of FIG. 18 and/or network node 2000 of FIG. 20), and host (such as host 1816 of FIG. 18 and/or host 2100 of FIG. 21) discussed in the preceding paragraphs will now be described with reference to FIG. 23.

Like host 2100, embodiments of host 2302 include hardware, such as a communication interface, processing circuitry, and memory. The host 2302 also includes software, which is stored in or accessible by the host 2302 and executable by the processing circuitry. The software includes a host application that may be operable to provide a service to a remote user, such as the UE 2306 connecting via an over-the-top (OTT) connection 2350 extending between the UE 2306 and host 2302. In providing the service to the remote user, a host application may provide user data which is transmitted using the OTT connection 2350.

The network node 2304 includes hardware enabling it to communicate with the host 2302 and UE 2306. The connection 2360 may be direct or pass through a core network (like core network 1806 of FIG. 18) and/or one or more other intermediate networks, such as one or more public, private, or hosted networks. For example, an intermediate network may be a backbone network or the Internet.

The UE 2306 includes hardware and software, which is stored in or accessible by UE 2306 and executable by the UE's processing circuitry. The software includes a client application, such as a web browser or operator-specific “app” that may be operable to provide a service to a human or non-human user via UE 2306 with the support of the host 2302. In the host 2302, an executing host application may communicate with the executing client application via the OTT connection 2350 terminating at the UE 2306 and host 2302. In providing the service to the user, the UE's client application may receive request data from the host's host application and provide user data in response to the request data. The OTT connection 2350 may transfer both the request data and the user data. The UE's client application may interact with the user to generate the user data that it provides to the host application through the OTT connection 2350.

The OTT connection 2350 may extend via a connection 2360 between the host 2302 and the network node 2304 and via a wireless connection 2370 between the network node 2304 and the UE 2306 to provide the connection between the host 2302 and the UE 2306. The connection 2360 and wireless connection 2370, over which the OTT connection 2350 may be provided, have been drawn abstractly to illustrate the communication between the host 2302 and the UE 2306 via the network node 2304, without explicit reference to any intermediary devices and the precise routing of messages via these devices.

As an example of transmitting data via the OTT connection 2350, in step 2308, the host 2302 provides user data, which may be performed by executing a host application. In some embodiments, the user data is associated with a particular human user interacting with the UE 2306. In other embodiments, the user data is associated with a UE 2306 that shares data with the host 2302 without explicit human interaction. In step 2310, the host 2302 initiates a transmission carrying the user data towards the UE 2306. The host 2302 may initiate the transmission responsive to a request transmitted by the UE 2306. The request may be caused by human interaction with the UE 2306 or by operation of the client application executing on the UE 2306. The transmission may pass via the network node 2304, in accordance with the teachings of the embodiments described throughout this disclosure. Accordingly, in step 2312, the network node 2304 transmits to the UE 2306 the user data that was carried in the transmission that the host 2302 initiated, in accordance with the teachings of the embodiments described throughout this disclosure. In step 2314, the UE 2306 receives the user data carried in the transmission, which may be performed by a client application executed on the UE 2306 associated with the host application executed by the host 2302.

In some examples, the UE 2306 executes a client application which provides user data to the host 2302. The user data may be provided in reaction or response to the data received from the host 2302. Accordingly, in step 2316, the UE 2306 may provide user data, which may be performed by executing the client application. In providing the user data, the client application may further consider user input received from the user via an input/output interface of the UE 2306. Regardless of the specific manner in which the user data was provided, the UE 2306 initiates, in step 2318, transmission of the user data towards the host 2302 via the network node 2304. In step 2320, in accordance with the teachings of the embodiments described throughout this disclosure, the network node 2304 receives user data from the UE 2306 and initiates transmission of the received user data towards the host 2302. In step 2322, the host 2302 receives the user data carried in the transmission initiated by the UE 2306.

One or more of the various embodiments improve the performance of OTT services provided to the UE 2306 using the OTT connection 2350, in which the wireless connection 2370 forms the last segment.

In an example scenario, factory status information may be collected and analyzed by the host 2302. As another example, the host 2302 may process audio and video data which may have been retrieved from a UE for use in creating maps. As another example, the host 2302 may collect and analyze real-time data to assist in controlling vehicle congestion (e.g., controlling traffic lights). As another example, the host 2302 may store surveillance video uploaded by a UE. As another example, the host 2302 may store or control access to media content such as video, audio, VR or AR which it can broadcast, multicast or unicast to UEs. As other examples, the host 2302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2350 between the host 2302 and UE 2306, in response to variations in the measurement results. The measurement procedure and/or the network functionality for reconfiguring the OTT connection may be implemented in software and hardware of the host 2302 and/or UE 2306. In some embodiments, sensors (not shown) may be deployed in or in association with other devices through which the OTT connection 2350 passes; the sensors may participate in the measurement procedure by supplying values of the monitored quantities exemplified above, or supplying values of other physical quantities from which software may compute or estimate the monitored quantities. The reconfiguring of the OTT connection 2350 may include message format, retransmission settings, preferred routing etc.; the reconfiguring need not directly alter the operation of the network node 2304. Such procedures and functionalities may be known and practiced in the art. In certain embodiments, measurements may involve proprietary UE signaling that facilitates measurements of throughput, propagation times, latency and the like, by the host 2302. The measurements may be implemented in that software causes messages to be transmitted, in particular empty or ‘dummy’ messages, using the OTT connection 2350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Example embodiments of the techniques and apparatus described herein include, but are not limited to, the following enumerated examples:

### Group A Embodiments

A1. A method performed by a communication device configured for use in a communication network, the method comprising:
   receiving, for each of one or more uplink channels or signals, a configuration that indicates with which of multiple activated unified transmission configuration indication, TCI, states the uplink channel or signal is associated.
A2. The method of embodiment A1, wherein the configuration for each uplink channel or signal includes a TCI state pointer that points to one or more of the multiple activated unified TCI states with which the uplink channel or signal is associated.
A3. The method of embodiment A2, wherein the TCI state pointer is a common beam index.
A4. The method of any of embodiments A2-A3, wherein activation signaling that activates the multiple unified TCI states associates the multiple activated unified TCI states with respective indices or identifiers, wherein the TCI state pointer included in the configuration for each uplink channel or signal points to one or more activated unified TCI states by pointing to the one or more indices or identifiers associated with the one or more activated unified TCI states.
A5. The method of embodiment A4, wherein the multiple activated unified TCI states includes first and second activated unified TCI states, wherein the activation signaling associates the first and second activated unified TCI states with first and second identifiers, respectively, wherein the TCI state pointer included in the configuration for at least one uplink channel or signal points to the first activated unified TCI state and/or the second activated unified TCI state by pointing to the first identifier, the second identifier, or both the first identifier and the second identifier.
A6. The method of embodiment A4, wherein the multiple activated unified TCI states includes first and second activated unified TCI states, wherein the activation signaling associates the first and second activated unified TCI states with first and second identifiers, respectively, wherein a field in downlink control signaling indicates whether:
   the TCI state pointer included in the configuration for at least one uplink channel or signal points to the first activated unified TCI state and/or the second activated unified TCI state by pointing to the first identifier, the second identifier, or both the first identifier and the second identifier; or
   the TCI state pointer included in the configuration for at least one uplink channel or signal points to the first activated unified TCI state and/or the second activated unified TCI state by pointing to the second identifier, the first identifier, or both the second identifier and the first identifier.
A7. The method of any of embodiments A5-A6, wherein the activation signaling includes a first field that activates the first activated unified TCI state and a second field that activates the second activated unified TCI state, and wherein the first field occurs before the second field in the activation signaling.
A8. The method of any of embodiments A4-A7, further comprising receiving the activation signaling.
A9. The method of embodiment A8, wherein the activation signaling is received after receipt of the configuration for at least one of the one or more uplink channels or signals.
A10. The method of any of embodiments A1-A9, wherein the configuration for each uplink channel or signal explicitly indicates with which of the multiple activated unified TCI states the uplink channel or signal is associated.
A11. The method of any of embodiments A1-A10, wherein the multiple activated unified TCI states are associated with multiple respective transmission reception points, TRPs.
A12. The method of any of embodiments A1-A11, wherein said receiving comprises receiving, for each of one or more uplink channels, a configuration that indicates with which of multiple activated unified TCI states the uplink channel is associated.
A13. The method of embodiment A12, wherein the one or more uplink channels include an uplink data channel.
A14. The method of embodiment A13, wherein the uplink data channel is a Physical Uplink Shared Channel, PUSCH.
A15. The method of embodiment A14, wherein the configuration received for the PUSCH is a PUSCH configuration or a PUSCH serving cell configuration.
A16. The method of any of embodiments A12-A15, wherein the configuration for the uplink data channel indicates the uplink data channel is associated with two or more of the multiple activated unified TCI states.
A17. The method of embodiment A16, further comprising:
   receiving a message that schedules or triggers two or more uplink data transmissions on the uplink data channel;
   determining two or more spatial filters for the two or more uplink data transmissions, respectively, based on the two or more activated unified TCI states with which the uplink data channel is associated; and
   performing the two or more uplink data transmissions on the uplink data channel using the two or more spatial filters.
A18. The method of embodiment A17, wherein the two or more uplink data transmissions are performed towards two or more TRPs, respectively.
A19. The method of any of embodiments A17-A18, wherein the two or more uplink data transmissions are scheduled to be performed:
   on the same frequency and spatial resources but during two or more respective time resources;
   during the same time resource and on the same spatial resource but on two or more respective frequency resources; or
   on the same frequency resource and during the same time resource but on two or more respective spatial resources.
A20. The method of any of embodiments A17-A18, wherein the two or more uplink data transmissions are scheduled to be performed:
   on the same frequency resources with one or more spatial filters during two or more respective time resources;
   during the same time resource but on two or more respective frequency resources with two or more spatial filters; or
   on the same frequency resource and during the same time resource but on two or more respective spatial filters.
A21. The method of any of embodiments A17-A20, wherein the two or more uplink data transmissions are repetitions of the same transport block.
A22. The method of any of embodiments A12-A20, wherein the one or more uplink channels include a reference uplink channel and one or more non-reference uplink channels, wherein the configuration for at least one non-reference uplink channel indicates the non-reference uplink channel is associated with whichever of the multiple activated unified TCI states the reference uplink channel is associated.
A22. The method of embodiment A21, wherein the reference uplink channel is an uplink channel in a certain bandwidth part and/or on a certain serving cell.
A23. The method of any of embodiments A1-A22, wherein the configuration for at least one uplink channel or signal includes a field that indicates whether a unified TCI framework or a spatial relation framework applies.
A24. The method of any of embodiments A1-A12, wherein said receiving comprises receiving, for each of one or more uplink signals, a configuration that indicates with which of multiple activated unified TCI states the uplink signal is associated.
A25. The method of embodiment A24, wherein the one or more uplink signals are one or more sounding reference signal, SRS, signals.
A26. The method of embodiment A25, wherein the one or more SRS signals are one or more SRS signals in one or more SRS resource sets.
A27. The method of embodiment A26, wherein the configuration for an SRS signal in an SRS resource set indicates with which of the multiple activated unified TCI states the SRS signal in that SRS resource set is associated by indicating with which of the multiple activated unified TCI states the SRS resource set is associated.
A28. The method of any of embodiments A26-A27, wherein the configuration received for each of the one or more SRS signals in the one or more SRS resource sets is an SRS resource set configuration.
A29. The method of any of embodiments A26-A28, further comprising:
   determining one or more spatial filters for transmission of the one or more SRS signals in the one or more SRS resource sets, based on one or more activated unified TCI states that are respectively associated with the one or more SRS signals in the one or more SRS resource sets; and
   performing the transmission of the one or more SRS signals in the one or more SRS resource sets using the one or more spatial filters.
A30. The method of embodiment A29, wherein the one or more SRS resource sets include two or more SRS resource sets in which are to be transmitted two or more SRS signals towards two or more TRPs, respectively.
A31. The method of any of embodiments A29-A30, further comprising:
   receiving a message that schedules or triggers one or more uplink data transmissions on an uplink data channel and that associates the one or more uplink data transmissions with one or more respective SRS resource sets;
   for each of the one or more uplink data transmissions, determining a spatial filter to use for performing the uplink data transmission based on an activated unified TCI state that is associated with the SRS resource set associated with the uplink data transmission; and
   performing the one or more uplink data transmissions on the uplink data channel using the one or more spatial filters determined for the one or more uplink data transmissions.
A32. The method of embodiment A31, wherein the one or more SRS resource sets include two or more SRS resource sets in which are transmitted two or more SRS signals towards two or more TRPs, respectively, and wherein the one or more uplink data transmissions include two or more uplink data transmissions performed towards the two or more TRPs, respectively.
A33. The method of embodiment A32, wherein the two or more uplink data transmissions are scheduled to be performed:
   on the same frequency and spatial resources but during two or more respective time resources;
   during the same time resource and on the same spatial resource but on two or more respective frequency resources; or
   on the same frequency resource and during the same time resource but on two or more respective spatial resources.
A34. The method of any of embodiments A32-A33, wherein the two or more uplink data transmissions are repetitions of the same transport block.
A35. The method of embodiment A25, wherein the one or more SRS signals are one or more SRS signals in one or more SRS resources of the same SRS resource set.
A36. The method of embodiment A35, wherein the configuration for an SRS signal in an SRS resource of the SRS resource set indicates with which of the multiple activated unified TCI states the SRS signal in that SRS resource is associated by indicating with which of the multiple activated unified TCI states the SRS resource is associated.
A37. The method of any of embodiments A35-A36, wherein the configuration received for each of the one or more SRS signals in the one or more SRS resources of the SRS resource set is an SRS resource configuration.
A38. The method of any of embodiments A35-A37, further comprising:
   determining one or more spatial filters for transmission of the one or more SRS signals in the one or more SRS resources, based on one or more activated unified TCI states that are respectively associated with the one or more SRS signals in the one or more SRS resources; and
   performing the transmission of the one or more SRS signals in the one or more SRS resources using the one or more spatial filters.
A39. The method of embodiment A38, wherein the one or more SRS resources include two or more SRS resource in which are transmitted two or more SRS signals towards two or more TRPs, respectively.
A40. The method of any of embodiments A38-A39, further comprising:
   receiving a message that schedules or triggers one or more uplink data transmissions on an uplink data channel and that associates the one or more uplink data transmissions with one or more respective SRS resources;
   for each of the one or more uplink data transmissions, determining a spatial filter to use for performing the uplink data transmission based on an activated unified TCI state that is associated with the SRS resource associated with the uplink data transmission; and
   performing the one or more uplink data transmissions on the uplink data channel using the one or more spatial filters determined for the one or more uplink data transmissions.
A41. The method of embodiment A40, wherein the one or more SRS resources include two or more SRS resources in which are transmitted two or more SRS signals towards two or more TRPs, respectively, and wherein the one or more uplink data transmissions include two or more uplink data transmissions performed towards the two or more TRPs, respectively.
A42. The method of embodiment A41, wherein the two or more uplink data transmissions are scheduled to be performed:
   on the same frequency and spatial resources but during two or more respective time resources;
   during the same time resource and on the same spatial resource but on two or more respective frequency resources; or
   on the same frequency resource and during the same time resource but on two or more respective spatial resources.
A43. The method of any of embodiments A41-A42, wherein the two or more uplink data transmissions are repetitions of the same transport block.
A44. The method of any of embodiments A1-A43, wherein each activated unified TCI state contains quasi co-location, QCL, information between antenna ports of the communication device.
A45. The method of any of embodiments A1-A44, wherein each activated unified TCI state is applicable for multiple channels or signals.
A46. The method of any of embodiments A1-A45, wherein the multiple activated unified TCI states are joint uplink/downlink TCI states, wherein each joint TCI state is applicable for both downlink transmissions and uplink transmissions.
A47. The method of any of embodiments A1-A45, wherein the multiple activated unified TCI states are uplink TCI states, wherein each uplink TCI state is applicable only for uplink transmissions.
A48. The method of any of embodiments A1-A47, further comprising determining, for each of the one or more uplink channels or signals, a spatial filter for the uplink channel or signal based on one or more activated unified TCI states that are associated with the uplink channel or signal according to the configuration received for that uplink channel or signal.
A49. The method of embodiment A48, further comprising transmitting the one or more uplink channels or signals using the one or more spatial filters determined for the one or more uplink channels or signals.
A50. The method of any of embodiments A1-A49, wherein said receiving comprises receiving, for each of one or more uplink channels or signals, a configuration that indicates with which of multiple unified TCI states that are activated and indicated the uplink channel or signal is associated.
AA. The method of any of the previous embodiments, further comprising:
   providing user data; and
   forwarding the user data to a host computer via the transmission to a base station.

### Group B Embodiments

B1. A method performed by a network node configured for use in a communication network, the method comprising:
   transmitting, to a communication device, for each of one or more uplink channels or signals, a configuration that indicates with which of multiple activated unified transmission configuration indication, TCI, states the uplink channel or signal is associated.
B2. The method of embodiment B1, wherein the configuration for each uplink channel or signal includes a TCI state pointer that points to one or more of the multiple activated unified TCI states with which the uplink channel or signal is associated.
B3. The method of embodiment B2, wherein the TCI state pointer is a common beam index.
B4. The method of any of embodiments B2-B3, wherein activation signaling that activates the multiple unified TCI states associates the multiple unified TCI states with respective indices or identifiers, wherein the TCI state pointer included in the configuration for each uplink channel or signal points to one or more activated unified TCI states by pointing to the one or more indices or identifiers associated with the one or more activated unified TCI states.
B5. The method of embodiment B4, wherein the multiple activated unified TCI states includes first and second activated unified TCI states, wherein the activation signaling associates the first and second activated unified TCI states with first and second identifiers, respectively, wherein the TCI state pointer included in the configuration for at least one uplink channel or signal points to the first activated unified TCI state and/or the second activated unified TCI state by pointing to the first identifier, the second identifier, or both the first identifier and the second identifier.
B6. The method of embodiment B4, wherein the multiple activated unified TCI states includes first and second activated unified TCI states, wherein the activation signaling associates the first and second activated unified TCI states with first and second identifiers, respectively, wherein a field in downlink control signaling indicates whether:
   the TCI state pointer included in the configuration for at least one uplink channel or signal points to the first activated unified TCI state and/or the second activated unified TCI state by pointing to the first identifier, the second identifier, or both the first identifier and the second identifier; or
   the TCI state pointer included in the configuration for at least one uplink channel or signal points to the first activated unified TCI state and/or the second activated unified TCI state by pointing to the second identifier, the first identifier, or both the second identifier and the first identifier.
B7. The method of any of embodiments B5-B6, wherein the activation signaling includes a first field that activates the first activated unified TCI state and a second field that activates the second activated unified TCI state, and wherein the first field occurs before the second field in the activation signaling.
B8. The method of any of embodiments B4-B7, further comprising transmitting the activation signaling.
B9. The method of embodiment B8, wherein the activation signaling is transmitted after transmission of the configuration for at least one of the one or more uplink channels or signals.
B10. The method of any of embodiments B1-B9, wherein the configuration for each uplink channel or signal explicitly indicates with which of the multiple activated unified TCI states the uplink channel or signal is associated.
B11. The method of any of embodiments B1-B10, wherein the multiple activated unified TCI states are associated with multiple respective transmission reception points, TRPs.
B12. The method of any of embodiments B1-B11, wherein said transmitting comprises transmitting, for each of one or more uplink channels, a configuration that indicates with which of multiple activated unified TCI states the uplink channel is associated.
B13. The method of embodiment B12, wherein the one or more uplink channels include an uplink data channel.
B14. The method of embodiment B13, wherein the uplink data channel is a Physical Uplink Shared Channel, PUSCH.
B15. The method of embodiment B14, wherein the configuration transmitted for the PUSCH is a PUSCH configuration or a PUSCH serving cell configuration.
B16. The method of any of embodiments B12-B15, wherein the configuration for the uplink data channel indicates the uplink data channel is associated with two or more of the multiple activated unified TCI states.
B17. The method of embodiment B16, further comprising:
   transmitting a message that schedules or triggers two or more uplink data transmissions on the uplink data channel;
   wherein two or more spatial filters for the two or more uplink data transmissions, respectively, are to be determined based on the two or more activated unified TCI states with which the uplink data channel is associated; and wherein the two or more uplink data transmissions are to be performed on the uplink data channel using the two or more spatial filters.
B18. The method of embodiment B17, wherein the two or more uplink data transmissions are performed towards two or more TRPs, respectively.
B19. The method of any of embodiments B17-B18, wherein the two or more uplink data transmissions are scheduled to be performed:
   on the same frequency and spatial resources but during two or more respective time resources;
   during the same time resource and on the same spatial resource but on two or more respective frequency resources; or
   on the same frequency resource and during the same time resource but on two or more respective spatial resources.
B20. The method of any of embodiments B17-B18, wherein the two or more uplink data transmissions are scheduled to be performed:
   on the same frequency resources with one or more spatial filters during two or more respective time resources;
   during the same time resource but on two or more respective frequency resources with two or more spatial filters; or
   on the same frequency resource and during the same time resource but on two or more respective spatial filters.
B21. The method of any of embodiments B17-B20, wherein the two or more uplink data transmissions are repetitions of the same transport block.
B22. The method of any of embodiments B12-B20, wherein the one or more uplink channels include a reference uplink channel and one or more non-reference uplink channels, wherein the configuration for at least one non-reference uplink channel indicates the non-reference uplink channel is associated with whichever of the multiple activated unified TCI states the reference uplink channel is associated.
B22. The method of embodiment B21, wherein the reference uplink channel is an uplink channel in a certain bandwidth part and/or on a certain serving cell.
B23. The method of any of embodiments B1-B22, wherein the configuration for at least one uplink channel or signal includes a field that indicates whether a unified TCI framework or a spatial relation framework applies.
B24. The method of any of embodiments B1-B12, wherein said transmitting comprises transmitting, for each of one or more uplink signals, a configuration that indicates with which of multiple activated unified TCI states the uplink signal is associated.
B25. The method of embodiment B24, wherein the one or more uplink signals are one or more sounding reference signal, SRS, signals.
B26. The method of embodiment B25, wherein the one or more SRS signals are one or more SRS signals in one or more SRS resource sets.
B27. The method of embodiment B26, wherein the configuration for an SRS signal in an SRS resource set indicates with which of the multiple activated unified TCI states the SRS signal in that SRS resource set is associated by indicating with which of the multiple activated unified TCI states the SRS resource set is associated.
B28. The method of any of embodiments B26-B27, wherein the configuration transmitted for each of the one or more SRS signals in the one or more SRS resource sets is an SRS resource set configuration.
B29. The method of any of embodiments B26-B28, wherein:
   one or more spatial filters for transmission of the one or more SRS signals in the one or more SRS resource sets are to be determined based on one or more activated unified TCI states that are respectively associated with the one or more SRS signals in the one or more SRS resource sets; and
   wherein transmission of the one or more SRS signals in the one or more SRS resource sets is to be performed using the one or more spatial filters.
B30. The method of embodiment B29, wherein the one or more SRS resource sets include two or more SRS resource sets in which are to be transmitted two or more SRS signals towards two or more TRPs, respectively.
B31. The method of any of embodiments B29-B30, further comprising:
   transmitting a message that schedules or triggers one or more uplink data transmissions on an uplink data channel and that associates the one or more uplink data transmissions with one or more respective SRS resource sets;
   for each of the one or more uplink data transmissions, a spatial filter that the communication device is to use for performing the uplink data transmission is to be determined based on an activated unified TCI state that is associated with the SRS resource set associated with the uplink data transmission; and
   wherein the one or more uplink data transmissions on the uplink data channel are to be performed using the one or more spatial filters determined for the one or more uplink data transmissions.
B32. The method of embodiment B31, wherein the one or more SRS resource sets include two or more SRS resource sets in which are transmitted two or more SRS signals towards two or more TRPs, respectively, and wherein the one or more uplink data transmissions include two or more uplink data transmissions performed towards the two or more TRPs, respectively.
B33. The method of embodiment B32, wherein the two or more uplink data transmissions are scheduled to be performed:
   on the same frequency and spatial resources but during two or more respective time resources;
   during the same time resource and on the same spatial resource but on two or more respective frequency resources; or
   on the same frequency resource and during the same time resource but on two or more respective spatial resources.
B34. The method of any of embodiments B32-B33, wherein the two or more uplink data transmissions are repetitions of the same transport block.
B35. The method of embodiment B25, wherein the one or more SRS signals are one or more SRS signals in one or more SRS resources of the same SRS resource set.
B36. The method of embodiment B35, wherein the configuration for an SRS signal in an SRS resource of the SRS resource set indicates with which of the multiple activated unified TCI states the SRS signal in that SRS resource is associated by indicating with which of the multiple activated unified TCI states the SRS resource is associated.
B37. The method of any of embodiments B35-B36, wherein the configuration transmitted for each of the one or more SRS signals in the one or more SRS resources of the SRS resource set is an SRS resource configuration.
B38. The method of any of embodiments B35-B37, wherein:
   one or more spatial filters for transmission of the one or more SRS signals in the one or more SRS resources are to be determined based on one or more activated unified TCI states that are respectively associated with the one or more SRS signals in the one or more SRS resources; and
   wherein transmission of the one or more SRS signals in the one or more SRS resources is to be performed using the one or more spatial filters.
B39. The method of embodiment B38, wherein the one or more SRS resources include two or more SRS resource in which are transmitted two or more SRS signals towards two or more TRPs, respectively.
B40. The method of any of embodiments B38-B39, further comprising:
   transmitting a message that schedules or triggers one or more uplink data transmissions on an uplink data channel and that associates the one or more uplink data transmissions with one or more respective SRS resources;
   wherein, for each of the one or more uplink data transmissions, a spatial filter that the communication device is to use for performing the uplink data transmission is to be determined based on an activated unified TCI state that is associated with the SRS resource associated with the uplink data transmission; and
   wherein the one or more uplink data transmissions on the uplink data channel are to be performed using the one or more spatial filters determined for the one or more uplink data transmissions.
B41. The method of embodiment B40, wherein the one or more SRS resources include two or more SRS resources in which are transmitted two or more SRS signals towards two or more TRPs, respectively, and wherein the one or more uplink data transmissions include two or more uplink data transmissions performed towards the two or more TRPs, respectively.
B42. The method of embodiment B41, wherein the two or more uplink data transmissions are scheduled to be performed:
   on the same frequency and spatial resources but during two or more respective time resources;
   during the same time resource and on the same spatial resource but on two or more respective frequency resources; or
   on the same frequency resource and during the same time resource but on two or more respective spatial resources.
B43. The method of any of embodiments B41-B42, wherein the two or more uplink data transmissions are repetitions of the same transport block.
B44. The method of any of embodiments B1-B43, wherein each activated unified TCI state contains quasi co-location, QCL, information between antenna ports of the communication device.
B45. The method of any of embodiments B1-B44, wherein each activated unified TCI state is applicable for multiple channels or signals.
B46. The method of any of embodiments B1-B45, wherein the multiple activated unified TCI states are joint uplink/downlink TCI states, wherein each joint TCI state is applicable for both downlink transmissions and uplink transmissions.
B47. The method of any of embodiments B1-B45, wherein the multiple activated unified TCI states are uplink TCI states, wherein each uplink TCI state is applicable only for uplink transmissions.
BB. The method of any of the previous embodiments, further comprising:
   obtaining user data; and
   forwarding the user data to a host computer or a communication device.

### Group C Embodiments

C1. A communication device configured to perform any of the steps of any of the Group A embodiments.
C2. A communication device comprising processing circuitry configured to perform any of the steps of any of the Group A embodiments.
C3. A communication device comprising:
   communication circuitry; and
   processing circuitry configured to perform any of the steps of any of the Group A embodiments.
C4. A communication device comprising:
   processing circuitry configured to perform any of the steps of any of the Group A embodiments; and
   power supply circuitry configured to supply power to the communication device.
C5. A communication device comprising:
   processing circuitry and memory, the memory containing instructions executable by the processing circuitry whereby the communication device is configured to perform any of the steps of any of the Group A embodiments.
C6. The communication device of any of embodiments C₁-C₅, wherein the communication device is a wireless communication device.
C7. A user equipment (UE) comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
C8. A computer program comprising instructions which, when executed by at least one processor of a communication device, causes the communication device to carry out the steps of any of the Group A embodiments.
C9. A carrier containing the computer program of embodiment C7, wherein the carrier is one of an electronic signal, optical signal, radio signal, or computer readable storage medium.
C10. A network node configured to perform any of the steps of any of the Group B embodiments.
C11. A network node comprising processing circuitry configured to perform any of the steps of any of the Group B embodiments.
C12. A network node comprising:
   communication circuitry; and
   processing circuitry configured to perform any of the steps of any of the Group B embodiments.
C13. A network node comprising:
   processing circuitry configured to perform any of the steps of any of the Group B embodiments;
   power supply circuitry configured to supply power to the network node.
C14. A network node comprising:
   processing circuitry and memory, the memory containing instructions executable by the processing circuitry whereby the network node is configured to perform any of the steps of any of the Group B embodiments.
C15. The network node of any of embodiments C10-C14, wherein the network node is a base station.
C16. A computer program comprising instructions which, when executed by at least one processor of a network node, causes the network node to carry out the steps of any of the Group B embodiments.
C17. The computer program of embodiment C16, wherein the network node is a base station.
C18. A carrier containing the computer program of any of embodiments C16-C17, wherein the carrier is one of an electronic signal, optical signal, radio signal, or computer readable storage medium.

### Group D Embodiments

D1. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
D2. The communication system of the previous embodiment further including the base station.
D3. The communication system of the previous 2 embodiments, further including the UE, wherein the UE is configured to communicate with the base station.
D4. The communication system of the previous 3 embodiments, wherein:
   the processing circuitry of the host computer is configured to execute a host application, thereby providing the user data; and
   the UE comprises processing circuitry configured to execute a client application associated with the host application.
D5. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
D6. The method of the previous embodiment, further comprising, at the base station, transmitting the user data.
D7. The method of the previous 2 embodiments, wherein the user data is provided at the host computer by executing a host application, the method further comprising, at the UE, executing a client application associated with the host application.
D8. A user equipment (UE) configured to communicate with a base station, the UE comprising a radio interface and processing circuitry configured to perform any of the previous 3 embodiments.
D9. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A embodiments.
D10. The communication system of the previous embodiment, wherein the cellular network further includes a base station configured to communicate with the UE.
D11. The communication system of the previous 2 embodiments, wherein:
   the processing circuitry of the host computer is configured to execute a host application, thereby providing the user data; and
   the UE's processing circuitry is configured to execute a client application associated with the host application.
D12. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
D13. The method of the previous embodiment, further comprising at the UE, receiving the user data from the base station.
D14. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A embodiments.
D15. The communication system of the previous embodiment, further including the UE.
D16. The communication system of the previous 2 embodiments, further including the base station, wherein the base station comprises a radio interface configured to communicate with the UE and a communication interface configured to forward to the host computer the user data carried by a transmission from the UE to the base station.
D17. The communication system of the previous 3 embodiments, wherein:
   the processing circuitry of the host computer is configured to execute a host application; and
   the UE's processing circuitry is configured to execute a client application associated with the host application, thereby providing the user data.
D18. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
D19. A method implemented in a communication system including a host computer, a base station and a user equipment (UE), the method comprising:
   at the host computer, receiving user data transmitted to the base station from the UE, wherein the UE performs any of the steps of any of the Group A embodiments.
D20. The method of the previous embodiment, further comprising, at the UE, providing the user data to the base station.
D21. The method of the previous 2 embodiments, further comprising:
   at the UE, executing a client application, thereby providing the user data to be transmitted; and
   at the host computer, executing a host application associated with the client application.
D22. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
D23. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
D24. The communication system of the previous embodiment further including the base station.
D25. The communication system of the previous 2 embodiments, further including the UE, wherein the UE is configured to communicate with the base station.
D26. The communication system of the previous 3 embodiments, wherein:
   the processing circuitry of the host computer is configured to execute a host application;
   the UE is configured to execute a client application associated with the host application, thereby providing the user data to be received by the host computer.
D27. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
D28. The method of the previous embodiment, further comprising at the base station, receiving the user data from the UE.
D29. The method of the previous 2 embodiments, further comprising at the base station, initiating a transmission of the received user data to the host computer.

### Group E Embodiments

1. A method in a UE for determining spatial filter for PUSCH transmission using the Unified TCI state framework for mTRP operation, where the method consist of:
   a. Receiving explicit configuration of one or more common beam indexes, where a first common beam index is associated with a first indicated Joint DL/UL TCI state and a second common beam index is associated with a second indicated Joint DL/UL TCI states
   b. Determine a first spatial filter for a first PUSCH transmission based on a first explicitly configured common beam index, and determining a second spatial filter for a second PUSCH transmission based on a second explicitly configured common beam index
2. 1 and where the explicit configuration (1a) is done in PUSCH-config
3. 1 and where the explicit configuration (1a) is done per SRS resource set with usage ‘codebook’ or ‘non-codebook’
4. 1 and where the explicit configuration (1a) is done per SRS resource in one SRS resource set with usage ‘codebook’ or ‘non-codebook’
5. 2 and where determining a first spatial filter for a first PUSCH transmission is based on a codepoint of a DCI bitfield in the DCI used to trigger the PUSCH
6. 2 and where determining a first spatial filter for a first PUSCH transmission is based on a CDM group number of the antenna (DMRS) ports indicated in the DCI used to trigger the PUSCH
7. 3 and where determining a first spatial filter for a first PUSCH transmission is based on the common beam index configured in an SRS resource set with usage ‘codebook’ or ‘non-codebook’ that associated with the PUSCH transmission
8. 7 and where there are two SRI/TPMI fields in the DCI used to trigger the PUSCH, and each SRI/TPMI field is associated to one out of two an SRS resource set with usage ‘codebook’ or ‘non-codebook’, and where the PUSCH transmission indicated with the SRI/TPMI associated with a first SRS resource set will be transmitted with a spatial filter based on the common beam index configured in that SRS resource set
9. 4 and where determining a first spatial filter for a first PUSCH transmission is based on the common beam index configured in an SRS resource in an SRS resource set with usage ‘codebook’ or ‘non-codebook’
10. 9 and where one or more layers of the PUSCH associated with a first SRS resource will be transmitted with a spatial filter based on the common beam index configured in that SRS resource
11. 10 and where an SRI/TPMI field in the DCI used to trigger the PUSCH indicates the layers to be transmitted per SRS resource
12. 3,4 and where one of the two SRS resource sets or SRS resources is in-activated in case a single common beam (i.e. only one Joint DL/UL TCI state) is indicated for the UE
13. 3 and where the UE determines spatial filter for the SRS resource set based on the explicitly configured common beam index for that SRS resource set
14. 4 and where the UE determines spatial filter for the SRS resource based on the explicitly configured common beam index for that SRS resource
15. 2 and where the common beam index only is configured in a reference PUSCH config, and other PUSCH configs can be explicitly linked to the reference PUSCH config
16. 15 and where the linked PUSCH config(s) should apply the same common beam index configurations as the reference PUSCH config
17.2 and where an additional flag is configured in PUSCH config, and only if the flag is configured the UE should use the unified TCI state framework to derive the spatial filter for mTRP PUSCH transmission (otherwise the UE should use the legacy Rel-15/16 TCI state framework to determine the spatial filters)

1.-58. (canceled)

59. A method performed by a communication device configured for use in a communication network, the method comprising:
receiving, for each of one or more uplink channels or signals, a configuration that indicates with which of multiple activated unified transmission configuration indication (TCI) states the uplink channel or signal is associated;
determining, for each of the one or more uplink channels or signals, a spatial filter for the uplink channel or signal based on one or more activated unified TCI states that are associated with the uplink channel or signal according to the configuration received for that uplink channel or signal; and
transmitting the one or more uplink channels or signals using the one or more spatial filters determined for the one or more uplink channels or signals.

60. The method of claim 59, wherein the configuration for each uplink channel or signal includes a TCI state pointer that points to one or more of the multiple activated unified TCI states with which the uplink channel or signal is associated.

61. The method of claim 60, further comprising receiving activation signaling that activates the multiple unified TCI states, wherein the activation signaling associates the multiple activated unified TCI states with respective indices or identifiers, wherein the TCI state pointer included in the configuration for each uplink channel or signal points to one or more activated unified TCI states by pointing to the one or more indices or identifiers associated with the one or more activated unified TCI states.

62. The method of claim 61, wherein the multiple activated unified TCI states includes first and second activated unified TCI states, wherein the activation signaling associates the first and second activated unified TCI states with first and second identifiers, respectively, wherein the TCI state pointer included in the configuration for at least one uplink channel or signal points to the first activated unified TCI state or the second activated unified TCI state by pointing to the first identifier or the second identifier.

63. The method of claim 61, wherein the multiple indicated unified TCI states includes first and second indicated unified TCI states, wherein the activation signaling associates the first and second indicated unified TCI states with first and second identifiers, respectively, wherein the TCI state pointer included in the configuration for at least one uplink channel or signal points to the first indicated unified TCI state and/or the second indicated unified TCI state by pointing to the first identifier, the second identifier, or both the first identifier and the second identifier.

64. The method of claim 61, wherein the multiple indicated unified TCI states includes first and second indicated unified TCI states, wherein the activation signaling associates the first and second indicated unified TCI states with first and second identifiers, respectively, wherein a field in Downlink Control Information (DCI) signaling indicates to which of the first identifier and the second identifier the TCI state pointer included in the configuration for at least one uplink channel or signal points.

65. The method of claim 61, wherein the activation signaling is Medium Access Control (MAC) signaling.

66. The method of claim 59, wherein the multiple activated unified TCI states are associated with multiple respective transmission reception points (TRPs).

67. The method of claim 59, wherein said receiving comprises receiving, for each of one or more uplink channels, a configuration that indicates with which of multiple activated unified TCI states the uplink channel is associated, wherein the one or more uplink channels include an uplink data channel.

68. A method performed by a network node configured for use in a communication network, the method comprising:
transmitting, to a communication device, for each of one or more uplink channels or signals, a configuration that indicates with which of multiple activated unified transmission configuration indication (TCI) states the uplink channel or signal is associated.

69. The method of claim 68, wherein the configuration for each uplink channel or signal includes a TCI state pointer that points to one or more of the multiple activated unified TCI states with which the uplink channel or signal is associated.

70. The method of claim 69, further comprising transmitting activation signaling that activates the multiple unified TCI states, wherein the activation signaling associates the multiple unified TCI states with respective indices or identifiers, wherein the TCI state pointer included in the configuration for each uplink channel or signal points to one or more activated unified TCI states by pointing to the one or more indices or identifiers associated with the one or more activated unified TCI states.

71. The method of claim 70, wherein the multiple activated unified TCI states includes first and second activated unified TCI states, wherein the activation signaling associates the first and second activated unified TCI states with first and second identifiers, respectively, wherein the TCI state pointer included in the configuration for at least one uplink channel or signal points to the first activated unified TCI state or the second activated unified TCI state by pointing to the first identifier or the second identifier.

72. The method of claim 70, wherein the multiple activated unified TCI states includes first and second activated unified TCI states, wherein the activation signaling associates the first and second activated unified TCI states with first and second identifiers, respectively, wherein the TCI state pointer included in the configuration for at least one uplink channel or signal points to the first activated unified TCI state and/or the second activated unified TCI state by pointing to the first identifier, the second identifier, or both the first identifier and the second identifier.

73. The method of claim 70, wherein the multiple activated unified TCI states includes first and second activated unified TCI states, wherein the activation signaling associates the first and second activated unified TCI states with first and second identifiers, respectively, wherein a field in downlink control signaling indicates to which of the first identifier and the second identifier the TCI state pointer included in the configuration for at least one uplink channel or signal points.

74. The method of claim 70, wherein the activation signaling is Medium Access Control (MAC) signaling.

75. The method of claim 68, wherein the multiple activated unified TCI states are associated with multiple respective transmission reception points (TRPs).

76. The method of claim 68, wherein said transmitting comprises transmitting, for each of one or more uplink channels, a configuration that indicates with which of multiple activated unified TCI states the uplink channel is associated, wherein the one or more uplink channels include an uplink data channel.

77. A communication device configured for use in a communication network, the communication device comprising:
communication circuitry; and
processing circuitry configured to:
receive, for each of one or more uplink channels or signals, a configuration that indicates with which of multiple activated unified transmission configuration indication (TCI) states the uplink channel or signal is associated;
determine, for each of the one or more uplink channels or signals, a spatial filter for the uplink channel or signal based on one or more activated unified TCI states that are associated with the uplink channel or signal according to the configuration received for that uplink channel or signal; and
transmit the one or more uplink channels or signals using the one or more spatial filters determined for the one or more uplink channels or signals.

78. The communication device of claim 77, wherein the configuration for each uplink channel or signal includes a TCI state pointer that points to one or more of the multiple activated unified TCI states with which the uplink channel or signal is associated.

79. The communication device of claim 78, wherein the processing circuitry is further configured to receive activation signaling that activates the multiple unified TCI states, wherein the activation signaling associates the multiple activated unified TCI states with respective indices or identifiers, wherein the TCI state pointer included in the configuration for each uplink channel or signal points to one or more activated unified TCI states by pointing to the one or more indices or identifiers associated with the one or more activated unified TCI states.

80. The communication device of claim 79, wherein the multiple activated unified TCI states includes first and second activated unified TCI states, wherein the activation signaling associates the first and second activated unified TCI states with first and second identifiers, respectively, wherein the TCI state pointer included in the configuration for at least one uplink channel or signal points to the first activated unified TCI state or the second activated unified TCI state by pointing to the first identifier or the second identifier.

81. The communication device of claim 79, wherein the multiple indicated unified TCI states includes first and second indicated unified TCI states, wherein the activation signaling associates the first and second indicated unified TCI states with first and second identifiers, respectively, wherein the TCI state pointer included in the configuration for at least one uplink channel or signal points to the first indicated unified TCI state and/or the second indicated unified TCI state by pointing to the first identifier, the second identifier, or both the first identifier and the second identifier.

82. The communication device of claim 79, wherein the multiple indicated unified TCI states includes first and second indicated unified TCI states, wherein the activation signaling associates the first and second indicated unified TCI states with first and second identifiers, respectively, wherein a field in Downlink Control Information (DCI) signaling indicates to which of the first identifier and the second identifier the TCI state pointer included in the configuration for at least one uplink channel or signal points.

83. The communication device of claim 79, wherein the activation signaling is Medium Access Control (MAC) signaling.

84. The communication device of claim 77, wherein the multiple activated unified TCI states are associated with multiple respective transmission reception points (TRPs).

85. A network node configured for use in a communication network, the network node comprising:
communication circuitry; and
processing circuitry transmit, to a communication device, for each of one or more uplink channels or signals, a configuration that indicates with which of multiple activated unified transmission configuration indication (TCI) states the uplink channel or signal is associated.
